(19) United States
(12) Patent Application Publication
(10) Pub. No.: US 2026/0195441 A1
(43) Pub. Date: Jul. 9, 2026

(54) IDENTITY SCORE CALCULATION DEVICE, IDENTITY AUTHENTICATION SYSTEM, IDENTITY AUTHENTICATION METHOD, AND PROGRAM

(71) Applicant: NTT, Inc., Tokyo (JP)

(72) Inventors: Yoshihiko OMORI, Tokyo (JP); Takao YAMASHITA, Tokyo (JP)

(73) Assignee: NTT, Inc., Tokyo (JP)

(21) Appl. No.: 19/133,237

(22) PCT Filed: Dec. 1, 2022
(86) PCT No.: PCT/JP2022/044480

§ 371 Date: May 28, 2025

(51) Int. Cl. G06F 21/45; G06F 21/31

(52) U.S. Cl. CPC G06F 21/45; G06F 21/31

(57) ABSTRACT

An identity score calculation device includes a probability calculation circuitry that calculates a point estimated value by performing point estimation of a proportion of users who are authentic people among all users who have accessed an account, including those who have not performed advanced authentication, on the basis of a statistical value obtained from authentication result information using numbers of users who have succeeded in and failed normal authentication and numbers of users who have succeeded in and failed advanced authentication, and performs interval estimation on the basis of the point estimated value within a preset confidence interval, which is a possible range of values for the proportion of users who are authentic people.

### CROSS-REFERENCE TO RELATED APPLICATION

This application is a national stage application, pursuant to 35 U.S.C. § 371, of International Patent Application No. PCT/JP2022/044480, filed Dec. 1, 2022, the entire contents of which are incorporated herein by reference.

### TECHNICAL FIELD

The present invention relates to an identity score calculation device, an identity authentication system, an identity authentication method, and a program for quantitatively estimating whether a user who accesses an account of a web service or an online system is an authorized user.

### BACKGROUND ART

A single sign on (SSO) system is known as a convenient login method for a user. Single sign on means a mechanism that enables use of a plurality of systems (web service, in-house system, cloud service, and the like) by single user authentication.

For example, in a single sign on system 1a as illustrated in FIG. 21, information regarding behavior of a user is collected, and a score of authenticity of the user is calculated in an authenticity score calculation function (identity score calculation device 10a in FIG. 21). Examples of the information regarding behavior of a user include an access time to an account of a user, a used terminal or device, position information at the time of access, and the like.

Furthermore, an authentication function of the single sign on system 1a (authentication device 20a in FIG. 21) performs strict authentication such as two-factor authentication for a user having low authenticity (high score) on the basis of the score of the authenticity of the user calculated by the identity score calculation device 10a, and then permits the user to access the account.

Note that, in the present specification, “authenticity” means a reliability with respect to that a user who accesses an account is a true user (authentic person) associated with the account.

A flow of processing of authentic person authentication in the single sign on system 1a illustrated in FIG. 21 will be described. Note that, here, an example will be described in which, in an environment in which a user uses a web server 51, an in-house system 52, a cloud service 53, and the like as a system using single sign on (hereinafter sometimes referred to as “SSO”; the same applies to each drawing), the web server 51 is accessed.

(Step S1) First, the user accesses the web server 51 and makes a login request in order to use a web service using a user terminal 3.

(Step S2) The web server 51 performs redirection to the single sign on system 1a via the user terminal 3 in order to authenticate the user.

(Step S3) An authentication device 20a of the single sign on system 1a acquires, from the user terminal 3, position information and a terminal type (device information) as user behavior information.

(Step S4) The authentication device 20a transmits the position information and the terminal type (device information) together with an access time to the identity score calculation device 10a.

(Step S5) The identity score calculation device 10a stores the position information, the terminal type (device information), and the access time acquired from the authentication device 20a in a user behavior information table. Then, the identity score calculation device 10a calculates and records a score on the basis of a difference between information at the time of a past access and information at the time of current access for each piece of the position information, the terminal type (device information), and the access time.

The score of authenticity of the user calculated by the identity score calculation device 10a obtained by estimating, for each item of the user behavior information, whether the user who is trying to access an account is the owner of the account on the basis of the acquired user behavior information, and performing evaluation by a numerical value. In calculation of the score of authenticity, the larger the difference from the information at the time of a past access is, the larger the score is set. For example, in the position information, the value of the score will be higher if the connection is made from an area different from usual. In the terminal type (device information), the value of the score will be higher if the connection is made using a device different from usual. In the access time, the value of the score will be higher if the access time is different from usual. As illustrated in FIG. 22, the identity score calculation device 10a calculates and stores a value obtained by adding up numerical values obtained by performing evaluation for each item of the user behavior information as the score of the authenticity of the user.

(Step S6) The identity score calculation device 10a transmits the calculated score of the authenticity of the user to the authentication device 20a.

(Step S7) In a case where the score of the authenticity exceeds a preset threshold value, the authentication device 20a executes two-factor authentication and authenticates the user. In a case where the threshold value is not exceeded, the authentication device 20a authenticates the user using a default authentication method.

In this way, the single sign on system 1a can perform authentic person authentication using the score of authenticity.

On the other hand, there is a technology described in Non Patent Literature 1 as a technology related to authenticity of a user who accesses an account.

Non Patent Literature 1 describes a technology of estimating a proportion of authentic people among users who access an account of a web service or the like, and calculating an authenticity score to perform authentication. By combining this technology with authentication to estimate a proportion of unauthentic people, it is possible to mostly prevent the authentication success of unauthentic people.

### CITATION LIST

### Non Patent Literature

Non Patent Literature 1: Yoshihiko Omori, Takao Yamashita, “Akaunto ni akusesu suru yuza-gun no shinrai-sei kakutei gijutsu ni kansuru kento (in Japanese) (A study on technology to determine the reliability of a group of users accessing accounts)”, Multimedia, Distributed, Cooperative, and Mobile Symposium, July 2022

### SUMMARY OF INVENTION

### Technical Problem

However, in technologies described in FIGS. 21 and 22, since a score of authenticity of each individual user is quantified (scored), it is difficult to perform authentication in which security and convenience are optimized on the basis of the operation state (for example, change in a traffic volume considered to be an attack on a network or a server) of a network or a server (Issue A).

Furthermore, in the technology described in FIG. 21, since a score of authenticity of a user is scored on the basis of a unique standard for each product, a maintenance person of an account needs to acquire know-how different for each product for influence evaluation and response determination when a threat caused by a user who is not an authentic person (not the owner of the account, an impersonation, or the like) is generated (Issue B). Moreover, since authenticity of a user is quantified on the basis of a unique standard for each product, evaluating authenticity by combining numerical values of a plurality of products is difficult (Issue C).

On the other hand, in the technology described in FIG. 22, it is assumed that a parameter related to behavior of a user and a state transition probability are extracted on the basis of advanced knowledge of a maintenance person, and authenticity of a user cannot be quantified as a probability unless a probability that an attack occurs (probability of not being an authentic person), a probability that an incident causes another incident, and the like are known (Issue D).

Furthermore, the technology described in Non Patent Literature 1 has a problem in that it is not possible to know the certainty of an estimated value of the proportion of authentic people in calculating the score of the authenticity of the user (Issue E). In addition, it is conceivable that optimum control of the sample size cannot be performed in an operating environment in which the proportion of authentic people dynamically changes.

The present invention has been made in view of such issues, and an object of the present invention is to quantitatively visualize the certainty of a point estimated value of a proportion of authentic people in calculating a score of authenticity of a user.

### Solution to Problem

According to the present invention, there is provided an identity score calculation device that is connected to an authentication device that performs user authentication and calculates a score indicating authenticity of a user, wherein the authentication device includes a plurality of types of normal authentication means for normal authentication in which authentication having standard authentication strength is performed, and a plurality of types of advanced authentication means for advanced authentication of which strength is set in such a manner that failure of authentication is reduced to a first predetermined level or less when a user is an authentic person and success of authentication is reduced to a second predetermined level or less when a user is not an authentic person, the identity score calculation device including: a behavior information collection circuitry that collects behavior information indicating access information indicating a service use environment in which a user has accessed an account via a user terminal and action history information of the user; an authentication result collection circuitry that collects, from the authentication device, authentication result information indicating success or failure of the normal authentication and the advanced authentication; an advanced authentication control circuitry that determines whether to execute the advanced authentication in addition to the normal authentication for a user who has accessed an account within a predetermined period, determines, regarding a user for whom it is determined that the advanced authentication will be executed, one of the advanced authentication means that reduces failure of authentication to the first predetermined level or less when a user is an authentic person among the plurality of types of advanced authentication means with reference to the behavior information, and notifies the authentication device of the one of the advanced authentication means determined for the user for whom it is determined that the advanced authentication will be executed; and a probability calculation circuitry that calculates a point estimated value by performing point estimation of a proportion of users who are authentic people among all users who have accessed an account, including those who have not performed advanced authentication, on the basis of a statistical value obtained from the authentication result information on a number of users who have succeeded in the normal authentication, a number of users who have failed the normal authentication, a number of users who have succeeded in the advanced authentication and a number of users who have failed the advanced authentication, wherein the probability calculation circuitry performs interval estimation on the basis of the point estimated value within a preset confidence interval, which is a possible range of values for the proportion of users who are authentic people.

### Advantageous Effects of Invention

According to the present invention, it is possible to quantitatively visualize the certainty of a point estimated value of a proportion of authentic people in calculating a score of authenticity of a user.

### BRIEF DESCRIPTION OF DRAWINGS

FIG. 1 is a diagram illustrating an overall configuration of an identity authentication system according to the present embodiment.

FIG. 2 is a diagram for describing an outline of processing of the identity authentication system according to the present embodiment.

FIG. 3 is a diagram for describing authentication results of an authentic person and an unauthentic person according to the present embodiment.

FIG. 4 is a diagram illustrating a distribution function of a sample ratio and interval estimation in the identity authentication system according to the present embodiment.

FIG. 5 is a diagram illustrating a distribution function of a sample ratio and interval estimation in the identity authentication system according to the present embodiment.

FIG. 6 is a diagram illustrating a value of a correction term when a proportion of authentic people who have failed advanced authentication of the identity authentication system according to the present embodiment is changed from 0.01 to 0.5.

FIG. 7 is a diagram illustrating dynamic control of a sampling proportion and an extraction period of the identity authentication system according to the present embodiment.

FIG. 8 is a functional block diagram illustrating an example of a configuration of an identity score calculation device according to the present embodiment.

FIG. 9 is a diagram illustrating an example of a data configuration of authentication result information stored in an authentication result DB according to the present embodiment.

FIG. 10 is a diagram illustrating an example of a data configuration of behavior information (access information and action history information) stored in a behavior information DB according to the present embodiment.

FIG. 11 is a diagram illustrating an example of a data configuration of statistical information stored in a statistical information DB according to the present embodiment.

FIG. 12 is a functional block diagram illustrating an example of a configuration of an authentication device according to the present embodiment.

FIG. 13 is a diagram for describing selection processing of a normal authentication method by the authentication device according to the present embodiment.

FIG. 14 is a sequence diagram illustrating a flow of processing executed by the identity authentication system according to the present embodiment.

FIG. 15 is a sequence diagram illustrating a flow of interval estimation and sampling control processing of the identity authentication system according to the present embodiment.

FIG. 16 is a diagram illustrating an example of a data configuration of statistical information stored in the statistical information DB of the identity authentication system according to the present embodiment.

FIG. 17 is a diagram illustrating an example of a data configuration of sampling history information stored in the sampling information DB of the identity authentication system according to the present embodiment.

FIG. 18 is a diagram illustrating an example of a data configuration of list information of extraction proportions and extraction periods for each difference of point estimated values stored in the sampling information DB of the identity authentication system according to the present embodiment.

FIG. 19 is a diagram illustrating threshold value information stored in the sampling information DB of the identity authentication system according to the present embodiment.

FIG. 20 is a hardware configuration diagram illustrating an example of a computer that implements functions of the identity score calculation device and the authentication device according to the present embodiment.

FIG. 21 is a diagram for describing a single sign on system in the related art.

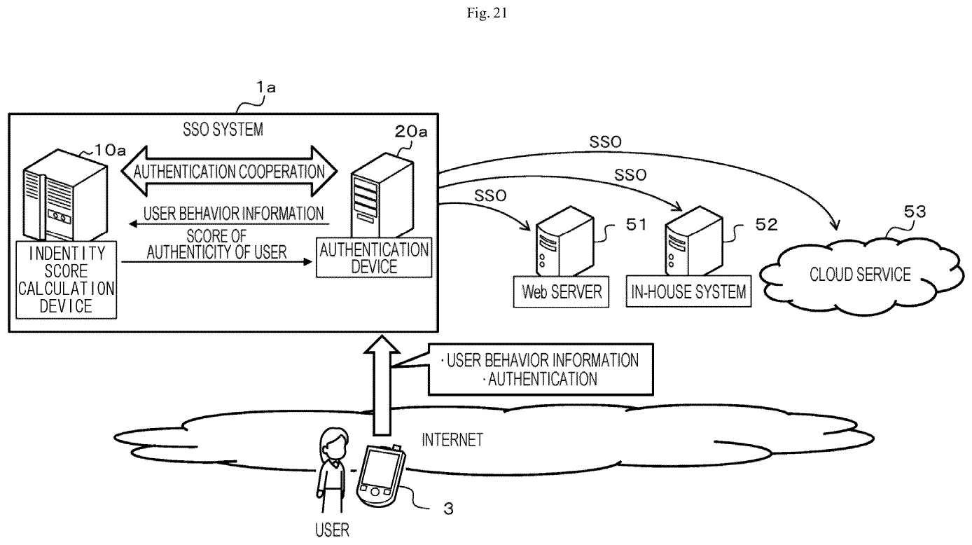

FIG. 22 is a diagram for describing an example of calculation of a score of authenticity of a user in the related art.

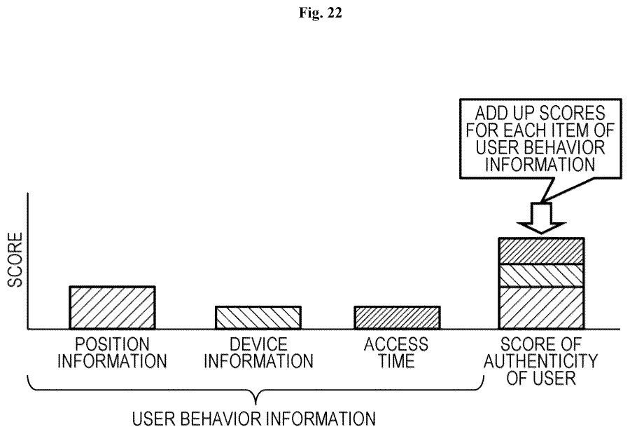

### DESCRIPTION OF EMBODIMENTS

Next, a mode for carrying out the present invention (hereinafter referred to as the “present embodiment”) will be described.

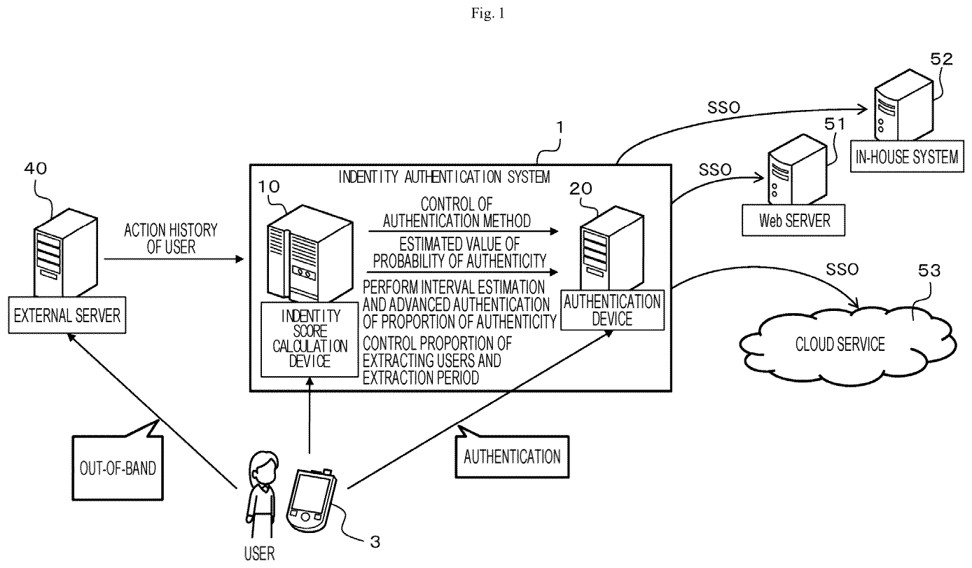

FIG. 1 is a diagram illustrating an overall configuration of an identity authentication system 1 according to the present embodiment.

The identity authentication system 1 according to the present embodiment is a single sign on (SSO) system configured with an authentication device 20 and an identity score calculation device 10. When the authentication device 20 of the identity authentication system 1 accepts authentication of a user, an account of the user is centrally managed by one-time authentication for a web server 51 that provides a web service, an in-house system 52, a cloud service 53, and the like.

Furthermore, the identity authentication system 1 collects information regarding behavior of a person associated with an account from a service use environment (position information, a use time, line information, ID information, and the like) and an action history without causing the user to take time and effort. For example, information of an action history of the user is acquired from an external server 40 (for example, a room access management server or the like). That is, information regarding behavior of a person associated with an account is acquired from a device or system (out-of-band) of a channel different from the authentication channel of the account. Then, the acquired information regarding behavior of a person is used for determination of selection of an authentication method (“advanced authentication method” to be described below).

Furthermore, the identity authentication system 1 calculates a point estimated value by performing point estimation of a proportion of users who are authentic people among all users who have accessed the account, including those who have not performed advanced authentication, and performs interval estimation on the basis of the point estimated value within a preset confidence interval, which is a possible range of values for the proportion of users who are authentic people (“interval estimation” described below). Furthermore, the identity authentication system 1 controls a proportion of extracting users who perform advanced authentication and/or an extraction period for sampling users who perform advanced authentication (“sampling control” described below).

### <Outline and Technical Idea>

First, an outline of the identity authentication system 1 according to the present embodiment and a technical idea for solving Issues A to D will be described.

In order to solve the above-described Issue A, the identity authentication system 1 according to the present embodiment evaluates a tendency of a proportion of authenticity among all users who access the web server 51, the in-house system 52, the cloud service 53, and the like during operation. That is, attention is paid to the proportion of authenticity among all users, instead of authenticity of each individual user. Furthermore, in order to solve the above-described Issues B and C, the identity authentication system 1 (identity score calculation device 10) enables evaluation of authenticity of a user who accesses the web server 51, the in-house system 52, the cloud service 53, and the like using a probability as an objective numerical value without depending on a unique standard of the device. Furthermore, in order to solve the above-described Issue D, the identity authentication system 1 (identity score calculation device 10) enables scoring of authenticity of a user who accesses the web server 51 and the like using observable information regarding behavior of a person associated with an account of the web server 51 and the like.

The technical idea related to a function (and processing) of the identity authentication system 1 for solving the above-described issues will be described.

In order to solve the above-described Issue A, the identity authentication system 1 according to the present embodiment enables (automatic) selection of a normal authentication method having optimum strength on the basis of an estimated value of a probability for evaluating a tendency of a proportion of authenticity among all users who access the web server 51, the in-house system 52, the cloud service 53, and the like. Furthermore, in order to solve Issues B and C, authenticity of a user can be evaluated using a probability as an objective numerical value without depending on a unique standard of the device. Furthermore, in order to solve Issue D, authenticity of a user who accesses a web service and the like can be scored using observable information regarding behavior of a person associated with an account of the web service and the like. That is, advanced knowledge and insight of a maintenance person such as past service operation results are unnecessary. Moreover, information regarding behavior of a person associated with an account is collected from a service use environment (position information, a use time, line information, ID information, and the like) and an action history without the user being caused to take time and effort.

Then, the identity authentication system 1 enables (automatic) selection of a normal authentication method having optimum strength on the basis of an estimated value of a probability of authenticity for all users.

In order to solve Issue E in addition to solving the above-described Issues A to D, the identity authentication system 1 introduces the following technical ideas to enable selection of the optimum normal authentication on the basis of a point estimated value of the probability of authenticity for all users, and to perform interval estimation to evaluate the certainty of the point estimated value.

### [Technical Idea 1: Advanced Authentication for Estimating Proportion of Unauthentic People]

The identity authentication system 1 uses both normal authentication conventionally performed by the authentication device 20 and “advanced authentication” for estimating a proportion of unauthentic people.

Here, the normal authentication is authentication having standard authentication strength as a procedure for permitting a user to use an account, and is, for example, authentication using a user ID and a password, which is widely used in the world.

In addition to the normal authentication, the identity authentication system 1 performs user authentication for estimating a proportion of users who are not authentic people (hereinafter, the users are referred to as “unauthentic people”) among a group of users who access an account for randomly sampled users (hereinafter, the authentication is referred to as “advanced authentication”).

The advanced authentication means user authentication having high strength, and means authentication at a level in which failure of authentication is mostly reduced in a case of a user who is an authentic person (failure of authentication is reduced to a first predetermined level or less in a case of a user who is an authentic person), and success of authentication is mostly reduced in a case of an unauthentic person (success of authentication is reduced to a second predetermined level or less in a case of an unauthentic person).

As the advanced authentication, an authentication method that is multifactor and having cryptographically sufficient strength is used, the authentication method being, for example, a smart card, short message service (SMS) authentication, or an out-of-band authentication method that requires unlocking or line use at the time of use.

Note that, in the present embodiment, the meaning of “be multifactor and have cryptographically sufficient strength” is used as the same meaning as “mostly reduce failure of authentication in a case of a user who is an authentic person (reduce failure of authentication to a first predetermined level or less in a case of a user who is an authentic person)”, and “mostly reduce success of authentication in a case of an unauthentic person (reduce success of authentication to a second predetermined level or less in a case of an unauthentic person)”.

[Technical Idea 2: Selecting Advanced Authentication That Can Reduce Failure of Authentication of Authentic Person of User from among Plurality of Types of Advanced Authentication]

The identity authentication system 1 prepares a plurality of advanced authentication methods, and selects advanced authentication that can reduce failure of authentication of a user who is an authentic person on the basis of information regarding behavior of a person associated with an account to be accessed.

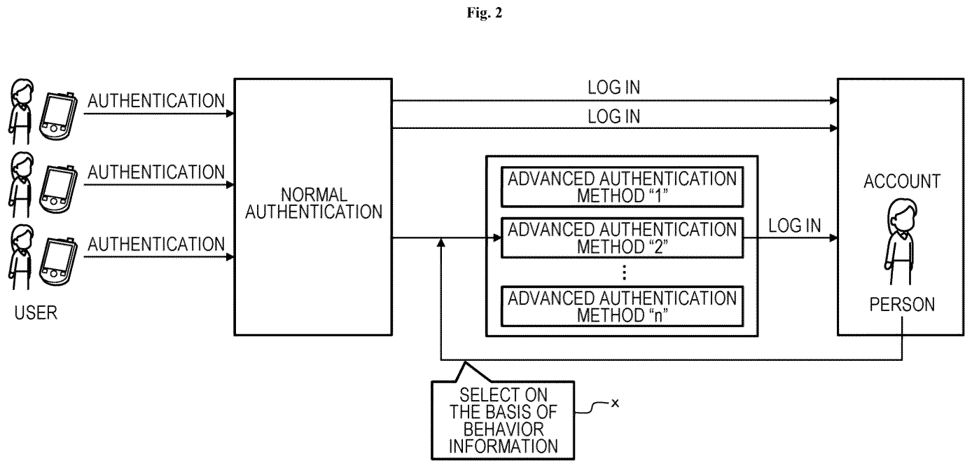

As illustrated in FIG. 2, the identity authentication system 1 includes a plurality of advanced authentication methods (advanced authentication methods “1” to “n”) in addition to the normal authentication. Then, for a randomly selected user among users who have requested access to the account, one of a plurality of types of advanced authentication (advanced authentication methods “1” to “n”) is selected and performed in addition to the normal authentication. The selection of an advanced authentication method is performed on the basis of information regarding behavior (“behavior information” to be described below) of a person (user) associated with an account to be accessed (symbol x in FIG. 2).

The selection of an advanced authentication method is performed, for example, as follows.

(Example 1) In a case where a person associated with an account to be accessed has recently succeeded in performing some authentication using a My Number Card on another account of an ID cooperation destination, advanced authentication using a My Number Card is selected.

(Example 2) In a case where a person associated with an account to be accessed has recently accessed a network from a pre-registered mobile terminal, advanced authentication using SMS is selected.

(Example 3) In a case where a person associated with an account to be accessed has entered an office and opened and closed a door using an employee ID card including an IC card function (smart card) at the time of entry and exit, advanced authentication using a smart card is selected.

(Example 4) In a case where a person associated with an account to be accessed plans to work at home, advanced authentication using a pre-registered line ID of a home is selected.

In this way, in the identity authentication system 1, behavior information of a person associated with an account to be accessed is stored, and advanced authentication is selected on the basis of real-time behavior of a person who has had access. Failure of authentication of an authentic person can be reduced using behavior information of a person.

### [Technical Idea 3: Method for Calculating Estimated Value of Probability of Authenticity for All Users]

The identity authentication system 1 estimates a probability of authenticity for all users using the following preconditions.

(Precondition 1) In a selected advanced authentication method, an authentic person mostly succeeds in authentication (failure of authentication is the first predetermined level or less in a case of a user who is an authentic person), and an unauthentic person mostly fails authentication (success of authentication is the second predetermined level or less in a case of an unauthentic person).

(Precondition 2) Access to an account by an unauthentic person is not related to a state of the account (environment such as whether it is in use, position information of using user, and line type). That is, it is assumed that the selection of an advanced authentication method described in Technical Idea 2 is not arbitrary with regard to a proportion of unauthentic people.

(Precondition 3) In a group of users (N₁) randomly sampled from all users (population N₂) who have requested authentication during a predetermined period, the following proportions can be approximated to those proportions in the population. Note that (Precondition 1) and (Precondition 2) are necessary to implement (Precondition 3).

$$[ Math . 1 ]$$

$$Authentic person who succeeds in normal authentication : ( \frac{{a}_{1}}{{N}_{1}} \text{?} \frac{{a}_{2}}{{N}_{2}} )$$

$$Authentic person who fails normal authentication : ( \frac{{c}_{1}}{{N}_{1}} \text{?} \frac{{c}_{2}}{{N}_{2}} )$$

$$Unauthentic person who succeeds in normal authentication : ( \frac{{b}_{1}}{{N}_{1}} \text{?} \frac{{b}_{2}}{{N}_{2}} )$$

$$Unauthentic person who fails normal authentication : ( \frac{{d}_{1}}{{N}_{1}} \text{?} \frac{{d}_{2}}{{N}_{2}} )$$

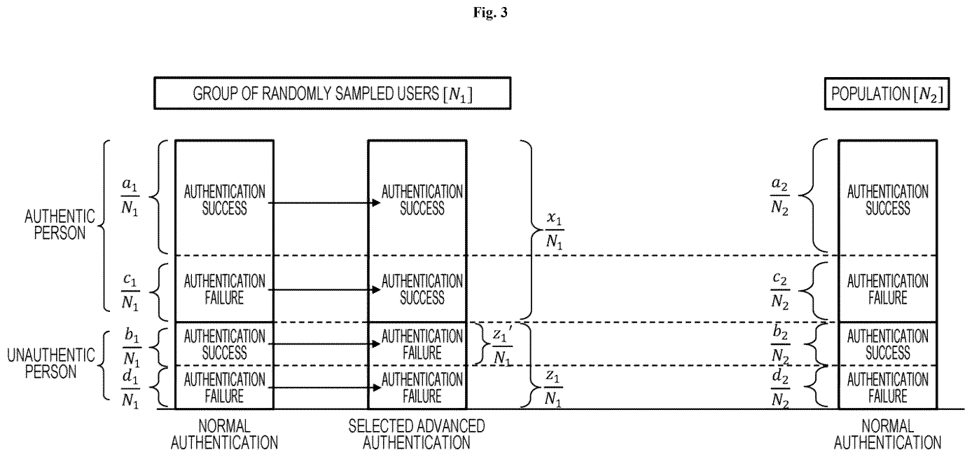

Here, as illustrated in FIG. 3, a₁ indicates the number of authentic people who have succeeded in the normal authentication and have also succeeded in a selected advanced authentication in the group of users (N₁). c₁ indicates the number of authentic people who have failed the normal authentication and have succeeded in the selected advanced authentication in the group of users (N₁). b₁ indicates the number of unauthentic people who have succeeded in the normal authentication and have failed the selected advanced authentication in the group of users (N₁). d₁ indicates the number of unauthentic people who have failed the normal authentication and have also failed the selected advanced authentication in the group of users (N₁).

Furthermore, a₂ indicates the number of authentic people who have succeeded in the normal authentication in the population (N₂). c₂ indicates the number of authentic people who have failed the normal authentication in the population (N₂). b₂ indicates the number of unauthentic people who have succeeded in the normal authentication in the population (N₂). d₂ indicates the number of unauthentic people who have failed the normal authentication in the population (N₂).

The identity authentication system 1 collects the following observable information on the basis of the selected advanced authentication method (see FIG. 3).

$$[ Math . 2 ]$$

$$Number of users who have succeeded in advanced authentication : {x}_{1} ( = {a}_{1} + {c}_{1} )$$

$$Number of users who have failed advanced authentication : {z}_{1} ( = {b}_{1} + {d}_{1} )$$

$$Number of users who have succeeded in normal authentication and have failed advanced authentication : {z}_{1}^{′} ( = {b}_{1} )$$

$$Number of users who have succeeded in normal authentication in population : {N}_{2}^{( a + b )} ( = {a}_{2} + {b}_{2} )$$

$$Number of users who have failed normal authentication in population : {N}_{2}^{( c + d )} ( = {c}_{2} + {d}_{2} )$$

Then, the identity authentication system 1 calculates “proportion β₂ of unauthentic people who succeed in normal authentication” and “ratio γ₂ of unauthentic people to all users” in the population on the basis of the following Formulas (1) and (2).

$$[ Math . 3 ]$$

$${β}_{2} = \frac{{b}_{2}}{{b}_{2} + {d}_{2}} = \frac{{b}_{1}}{{b}_{1} + {d}_{1}} = \frac{{z}_{1}^{′}}{{z}_{1}} ( = {β}_{1} ) \qquad Formula ( 1 )$$

$${γ}_{2} = \frac{{b}_{2} + {d}_{2}}{{a}_{2} + {b}_{2} + {c}_{2} + {d}_{2}} = \frac{{b}_{1} + {d}_{1}}{{a}_{1} + {b}_{1} + {c}_{1} + {d}_{1}} = \frac{{z}_{1}}{{x}_{1} + {z}_{1}} ( = {γ}_{1} ) \qquad Formula ( 2 )$$

This “proportion β₂ of unauthentic people who succeed in normal authentication” (Formula (1)) is the proportion of unauthentic people who succeed in normal authentication among unauthentic people who have had access within a predetermined period with all accounts targeted. This indicates the percentage of accounts that were taken over (and successfully authenticated) by unauthentic people per account.

The “ratio γ₂ of unauthentic people to all users” (Formula (2)) indicates the percentage of attacks per account.

a₂, b₂, c₂, and d₂ can be obtained by solving simultaneous equations using Formulas (1) and (2) and the above-described observable N₂^{(a+b)}=a₂+b₂ . . . . Formula (3) and N₂^{(c+d)}=c₂+d₂ . . . . Formula (4).

Specifically, the identity authentication system 1 calculates the “number of authentic people who succeed in normal authentication a₂”, the “number of unauthentic people who succeed in normal authentication b₂”, the “number of authentic people who fail normal authentication c₂”, and the “number of unauthentic people who fail normal authentication d₂” in the population by the following Formulas.

$$[ Math . 4 ]$$

$${a}_{2} = ( {a}_{2} + {b}_{2} ) - {b}_{2} = {N}_{2}^{( a + b )} - {β}_{1} {γ}_{1} {N}_{2} )$$

$${b}_{2} = {β}_{2} ( {b}_{2} + {d}_{2} ) = \frac{{z}_{1}^{′}}{{z}_{1}} ( {b}_{1} + {d}_{1} ) \frac{{N}_{2}}{{N}_{1}} = {β}_{1} \frac{{z}_{1}}{{x}_{1} + {z}_{1}} {N}_{2} = {β}_{1} {γ}_{1} {N}_{2} )$$

$${c}_{2} = {N}_{2}^{( c + d )} - {d}_{2} = {N}_{2}^{( c + d )} - ( 1 - {β}_{1} ) {γ}_{1} {N}_{2} )$$

$${d}_{2} = \frac{1 - {β}_{2}}{{β}_{2}} {b}_{2} = \frac{1 - {β}_{1}}{{β}_{1}} {b}_{2} = \frac{1 - {β}_{1}}{{β}_{1}} {β}_{1} {γ}_{1} {N}_{2} = ( 1 - {β}_{1} ) {γ}_{1} {N}_{2} )$$

Then, for a user who has succeeded in the normal authentication within a predetermined period, the identity authentication system 1 estimates authenticity using a probability of being an authentic person (Pₛ^{p}) (Formula (5)), and estimates authenticity using a probability of not being an authentic person (Pₛⁿ) (Formula (6)).

$$[ Math . 5 ]$$

$$Probability of being authentic person ( {P}_{S}^{p} ) : {P}_{S}^{p} = \frac{{a}_{2}}{{a}_{2} + {b}_{2}} = \frac{{N}_{2}^{( a + b )} - {β}_{1} {γ}_{1} {N}_{2}}{{N}_{2}^{( a + b )}} \qquad Formula ( 5 )$$

$$Probability of not being authentic person ( {P}_{S}^{n} ) : {P}_{S}^{n} = \frac{{b}_{2}}{{a}_{2} + {b}_{2}} = \frac{{β}_{1} {γ}_{1} {N}_{2}}{{N}_{2}^{( a + b )}} \qquad Formula ( 6 )$$

Furthermore, for a user who has failed the normal authentication within a predetermined period, the identity authentication system 1 estimates authenticity using a probability of being an authentic person (P_{f}^{p}) (Formula (7)), and estimates authenticity using a probability of not being an authentic person (P_{f}ⁿ) (Formula (8)).

$$[ Math . 6 ]$$

$$Probability of being authentic person ( {P}_{f}^{p} ) : {P}_{f}^{p} = \frac{{c}_{2}}{{c}_{2} + {d}_{2}} = \frac{{N}_{2}^{( c + d )} - ( 1 - {β}_{1} ) {γ}_{1} {N}_{2}}{{N}_{2}^{( c + d )}} \qquad Formula ( 7 )$$

$$Probability of not being authentic person ( {P}_{f}^{n} ) : {P}_{f}^{n} = \frac{{d}_{2}}{{c}_{2} + {d}_{2}} = \frac{( 1 - {β}_{1} ) {γ}_{1} {N}_{2}}{{N}_{2}^{( c + d )}} \qquad Formula ( 8 )$$

The identity authentication system 1 estimates a probability of being an authentic person (Pₜ) using the following Formula (9) for all users who have had access during a predetermined period.

$$[ Math . 7 ]$$

$$Probability of being authentic person ( {P}_{t} ) : {P}_{t} = \frac{{a}_{2} + {c}_{2}}{{a}_{2} + {b}_{2} + {c}_{2} + {d}_{2}} = 1 - {γ}_{1} \qquad Formula ( 9 )$$

In this way, in the identity authentication system 1, authenticity can be estimated using a probability of being an authentic person (P_{S}^{p}), that is, Formula (5) for a user who has succeeded in the normal authentication within a predetermined period.

Furthermore, in the identity authentication system 1, authenticity can be estimated using a probability of being an authentic person (Pₜ) including a case where the normal authentication has failed, that is, Formula (9).

The estimation of the proportion of authentic people (point estimation) has been described above.

Here, even if the proportion of the authentic people can be estimated (point estimation), (a) it is not possible to know the certainty of the estimated value of the proportion of authentic people. In addition, (b) in an operating environment in which the proportion of authentic people dynamically changes, there is a problem that it is difficult to optimally control the sample size (in this case, the number of users who perform advanced authentication),

The above (a) is addressed by [Interval Estimation for Evaluating Certainty of Authentic Person's Estimated Value] quantitatively visualizing the certainty of the estimated value.

The above (b) is handled by [Processing of Sampling Users Who Perform Advanced Authentication] of collecting samples over a limited period in order for the estimated value to follow the change in the proportion of authentic people. This sampling processing optimizes a proportion of the number of users who perform advanced authentication within a range of accuracy of an estimated value obtained at the time of operation. In a case where the proportion of the number of users who perform advanced authentication is high, the accuracy of the estimated value is high, and in a case where the proportion thereof is low, the accuracy of the estimated value is low.

Hereinafter, [Interval Estimation for Evaluating Certainty of Authentic Person's Estimated Value] and [Processing of Sampling Users Who Perform Advanced Authentication] will be described. [Technical Idea 4: Interval Estimation for Evaluating Certainty of Authentic Person's Estimated Value]

The identity authentication system 1 performs processing of performing interval estimation after processing of estimating the proportion of authentic people (point estimation).

The interval estimation is characterized in that the proportion of authentic people and the viewpoint of the proportion for which the advanced authentication has succeeded are combined in cooperation with the function of estimating the proportion of authentic people (point estimation).

With the interval estimation, it is possible to evaluate the certainty of the authentic person's estimated value, and it is possible to consider the influence of the authentic person failing the advanced authentication (False Negative).

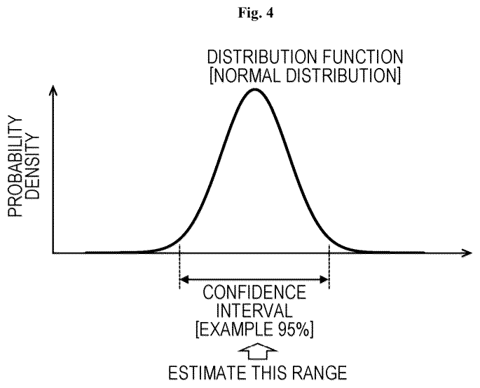

FIG. 4 is a diagram for describing the distribution function of the sample ratio and interval estimation. The horizontal axis represents the sample ratio, and the vertical axis represents the probability density.

As illustrated in FIG. 4, the distribution of the sample ratio (here, the proportion of authentic people) approximates the normal distribution as the sample size (here, the number of users who perform advanced authentication) increases, regardless of the distribution of the population. The range of the confidence interval (for example, 95%) illustrated in FIG. 4 is estimated.

After the processing of estimating the proportion of authentic people (point estimation), processing of performing interval estimation is added.

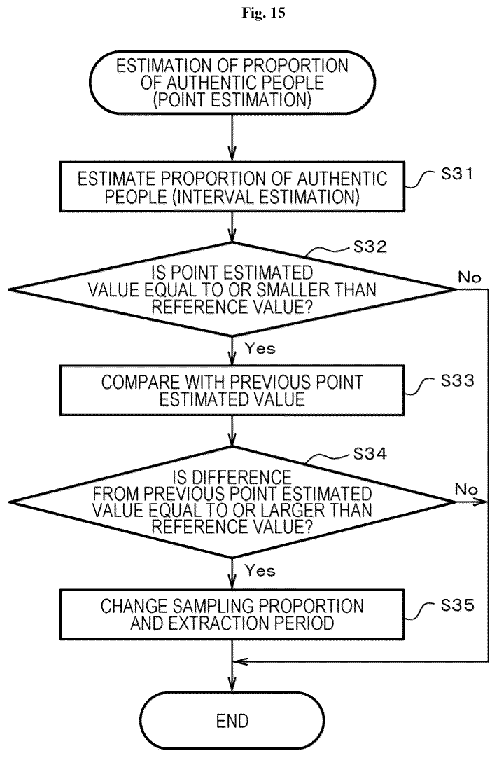

In addition, in the processing of sampling users who perform advanced authentication, processing (FIG. 15) is added in which, in a case where the point estimated value of the proportion of authentic people is equal to or smaller than a reference value, a reference value is set for the amount of change in the proportion of authentic people, and sampling is performed with the proportion and the extraction period according to the reference value. The reason for setting the reference value is to take user convenience into consideration.

### <Details of Method for Performing Interval Estimation of Proportion of Authentic People>

Details of the method for performing interval estimation of the proportion of authentic people will be described.

### Interval Estimation Formula for the Proportion p of Authentic People

An interval estimation formula for a proportion p of the authentic people is expressed by Formula (10).

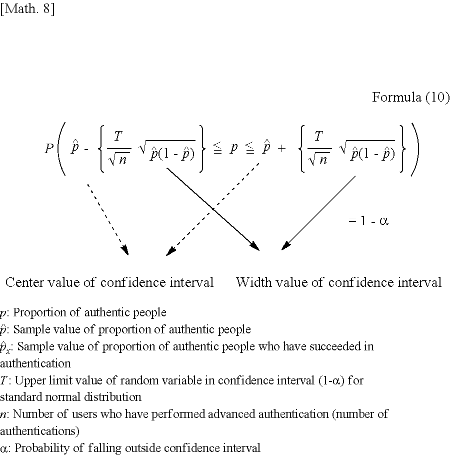

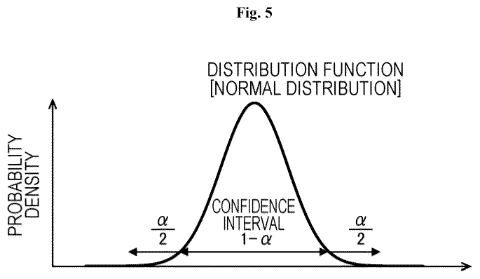

The above Formula (10) will be described with reference to FIG. 5.

FIG. 5 is a diagram for describing the distribution function of the sample ratio (here, the proportion p of authentic people) and interval estimation. The horizontal axis represents the sample ratio, and the vertical axis represents the probability density.

In a case where the proportion of authentic people is p and the sample value of the proportion of authentic people is p\hat{ }(“p hat”), p\hat{ } on the right side and the left side of p in P( ) in Formula (10) is the “center value of the confidence interval (1-α)” of the distribution function illustrated in FIG. 5. In addition, { } on the right side and the left side of p in Formula (10) is the “width value of the confidence interval (1-α)” of the distribution function illustrated in FIG. 5. α is the probability of falling outside the confidence interval, and for a normal distribution, α=α/2+α/2 is defined.

Interval Estimation Formula for the Proportion p of Authentic People in a Case where there are No Authentic People Who Fail Advanced Authentication

An interval estimation formula for the proportion p of authentic people in a case where there are no authentic people who fail advanced authentication is expressed by Formula (11) based on Formula (10), where p\hat{ }ₓ is the sample value of the proportion of authentic people who have succeeded in advanced authentication.

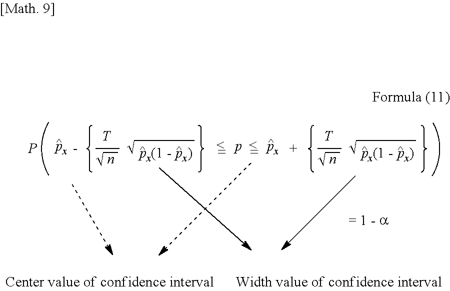

Interval Estimation Formula for the Proportion p of Authentic People in a Case where there are Authentic People Who Fail Advanced Authentication

In order to calculate the interval estimation formula for the proportion p of authentic people, it is necessary to add not only the number of users who have succeeded in advanced authentication but also the number of authentic people who have failed the advanced authentication (even the authentic people may fail advanced authentication).

In a case where there are authentic people who fail the advanced authentication, the sample value of the proportion of authentic people is calculated according to Formula (12) by counting the number of users who have succeeded in the advanced authentication and the number of authentic people who have failed the advanced authentication. That is, Formula (12) is a formula obtained by adding the sample value p\hat{ }_{y} of the proportion of authentic people who have failed the advanced authentication to the sample value p\hat{ }ₓ of the proportion of authentic people who have succeeded in advanced authentication, and specifically, p\hat{ }ₓ in Formula (11) is replaced with (p\hat{ }ₓ+p\hat{ }_{y}).

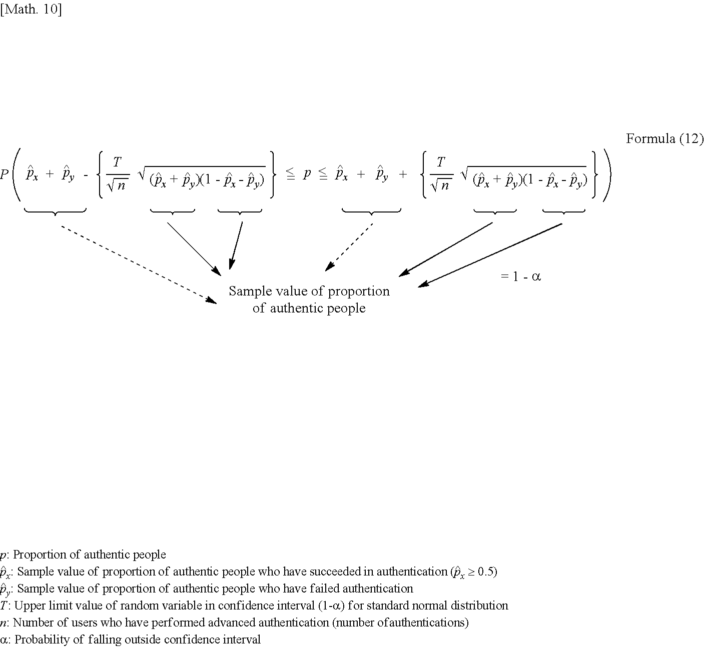

Formula Obtained by Adding a Correction Term to the Interval Estimation Formula for the Proportion p of Authentic People in a Case where there are Authentic People Who Fail Advanced Authentication

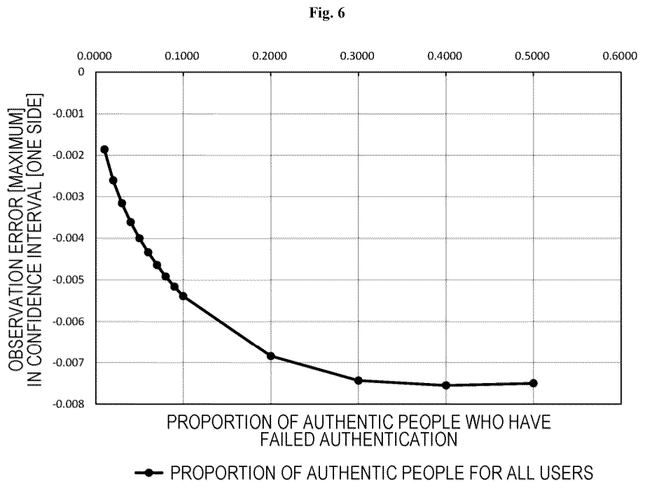

Formula (13) is an interval estimation formula that takes into consideration the safety by adding a correction term (described later in FIG. 6) to the interval estimation formula of Formula (12). A correction term (see Formula (13)) is added to each of the center value of the confidence interval and the width value of the confidence interval.

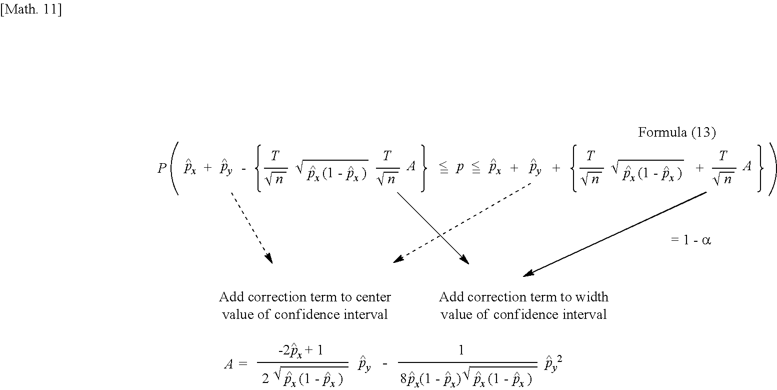

The above Formula (13) is the formula used for [Interval Estimation for Evaluating Certainty of Authentic Person's Estimated Value].

The results of advanced authentication (authentication success/authentication failure) are observed (sampled), and Formula (13) is applied to perform interval estimation of the proportion p of authentic people.

### Correction Term for the Center Value of the Confidence Interval

The correction term for the center value of the confidence interval (center value correction term) will be described.

(1) In a case where there is no correction term, an error will occur in the center value of the confidence interval, but the value will be estimated to be small. Therefore, the proportion of authentic people will be evaluated to be on the safe side in terms of NW security.

(2) The smaller the proportion p\hat{ }_{y} of authentic people who have failed advanced authentication, the smaller the value of the correction term.

(3) In a case where it is difficult to observe the proportion p\hat{ }_{y} of authentic people who have failed advanced authentication (users who have failed authentication include unauthentic people), it is difficult to calculate the correction term for the center value of the confidence interval. For this reason, in consideration of (1) and (2) above, the correction term is omitted, and the optimum advanced authentication is selected on the basis of the user's behavior, thereby reducing the probability of authentication failure.

### Correction Term for the Width Value of the Confidence Interval

The correction term for the width value of the confidence interval (width value correction term) will be described.

(1) In a case where there is no correction term (<0), an error will occur in the width value of the confidence interval, but the value will be estimated to be large (the width will be widened). For this reason, the evaluation will be performed on the safe side in terms of NW security.

(2) The value of the correction term decreases (the absolute value increases) as the proportion p\hat{ }_{y} of authentic people who have failed advanced authentication increases, but it can be assumed that the value is approximately −0.1% to −1% at the maximum in the actual operation range of the network.

(3) In a case where it is difficult to observe the proportion p\hat{ }_{y} of authentic people who have failed advanced authentication (users who have failed authentication include unauthentic people), it is difficult to calculate the correction term for the width value of the confidence interval. For this reason, in consideration of (1) and (2) above, the correction term is omitted, and the optimum super strong authentication is selected on the basis of the user's behavior, thereby reducing the probability of authentication failure.

### Correction Term for the Width Value of the Confidence Interval

The correction term for the width value of the confidence interval will be described.

FIG. 6 is a diagram illustrating a value of a correction term when a proportion of authentic people who have failed advanced authentication is changed from 0.01 to 0.5. The horizontal axis represents the proportion of authentic people who have failed advanced authentication, and the vertical axis represents the maximum value of the observation error in the confidence interval (one side of the distribution function in FIG. 5). The observation error in the confidence interval on the vertical axis is the value of the correction term. The value of the correction term in FIG. 6 was calculated under the condition that the absolute value thereof was maximized.

The black circles (⋅) in FIG. 6 indicate observation points, and the solid lines connecting them indicate the proportion of authentic people for all users. Among all users, the sum of the proportion of users who have succeeded in advanced authentication and the proportion of authentic people who have failed authentication was set to 1 (the condition that the absolute value was maximized). The number of users who have performed authentication (number of authentications) was set to n=10,000, and the upper limit value of the random variable in the confidence interval (1-α) for the standard normal distribution was set to T=3.

As the correction term for the width value of the confidence interval, the value of the correction term illustrated in FIG. 6 can be used.

As described above, by estimating the proportion of authentic people (point estimation) and then combining it with interval estimation using Formula (13), it is possible to evaluate the certainty of the authentic person's estimated value, and it is possible to consider the influence of the authentic person failing the advanced authentication.

### [Technical Idea 5: Processing of Sampling Users Who Perform Advanced Authentication]

In addition, the identity authentication system 1 ensures the immediacy of the calculation of the estimated value in order to follow the change in the proportion of authentic people at the time of operation while maintaining the accuracy of the estimated value of the proportion of authentic people. Therefore, the identity authentication system 1 controls the proportion of extracting samples (users who perform advanced authentication) and the extraction period. Specifically, the identity authentication system 1 dynamically sets the proportion of extracting samples and the extraction period on the basis of a difference between the estimated value of the proportion of authentic people and the estimated value at the previous measurement. As the estimated value, a point estimated value or an interval estimated value (for example, a lower limit value of the estimated value) is used.

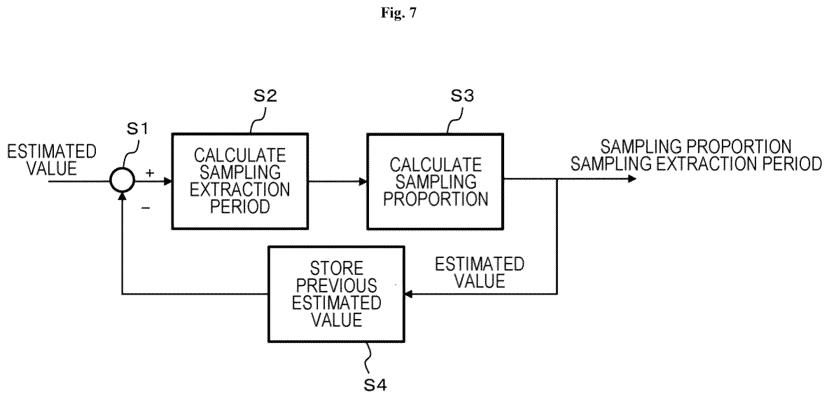

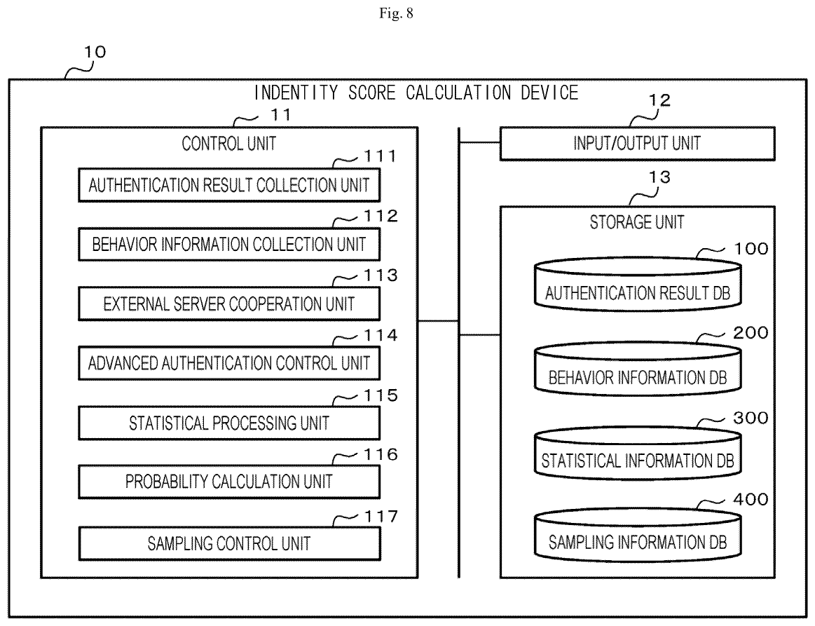

FIG. 7 is a diagram illustrating dynamic control of the sampling proportion and the extraction period. This feedback control is executed by a control circuitry 11 of the identity score calculation device 10 in FIG. 8.

As illustrated in FIG. 7, an estimated value of the proportion of authentic people is input, and a difference between the current estimated value and the estimated value at the previous measurement is obtained (step S1). In step S2, the difference from the estimated value at the previous measurement is input, and a sampling extraction period is calculated. In step S3, a sampling proportion is calculated on the basis of the calculated sampling extraction period, and the sampling proportion and the sampling extraction period are output as estimated values of the proportion of authentic people. In step S4, the output estimated value of the proportion of authentic people is stored as a previous estimated value.

In this way, in the processing of sampling users who perform advanced authentication, in a case where the point estimated value of the proportion of authentic people is equal to or smaller than a reference value, the identity authentication system 1 sets a reference for the amount of change in the proportion of authentic people, and performs processing of sampling with the proportion and the extraction period according to the reference.

Regarding the following of change in the proportion of authentic people, the proportion of samples and the extraction period are controlled in cooperation with the function of point estimation or interval estimation.

By controlling the proportion of samples (users who perform advanced authentication) and the extraction period using the point estimated value, it is possible to follow the change in the proportion of authentic people at the time of operation.

Next, the identity score calculation device 10 and the authentication device 20 included in the identity authentication system 1 according to the present embodiment will be specifically described.

### <Identity Score Calculation Device>

FIG. 8 is a functional block diagram illustrating an example of a configuration of the identity score calculation device 10 according to the present embodiment.

The identity score calculation device 10 acquires results of normal authentication and advanced authentication when the user accesses an account of the web server 51 or the like using a user terminal 3 from the authentication device 20, and calculates a probability of authenticity of the user who has had access. The identity score calculation device 10 collects a service use environment (position information, a use time, line information, ID information, and the like), an action history, and the like as “behavior information” as information regarding behavior of a person (user) associated with an account to be accessed, and selects an advanced authentication method capable of reducing failure of authentication by an authentic person.

The identity score calculation device 10 is configured with a computer including a control circuitry 11, an input/output circuitry 12, and a storage circuitry 13.

The input/output circuitry 12 inputs/outputs information to/from the authentication device 20, the external server 40 for acquiring behavior information, and the like. The input/output circuitry 12 includes a communication interface for transmitting and receiving information via a communication line, and an input/output interface that inputs and outputs information to and from an input device such as a keyboard (not illustrated) and an output device such as a monitor (not illustrated).

The storage circuitry 13 is configured with a hard disk, a flash memory, a random access memory (RAM), or the like.

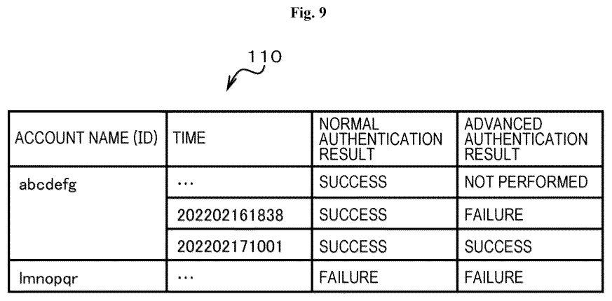

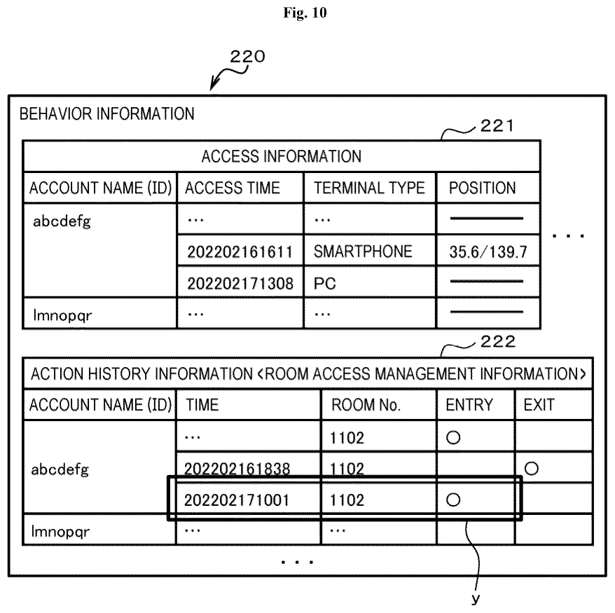

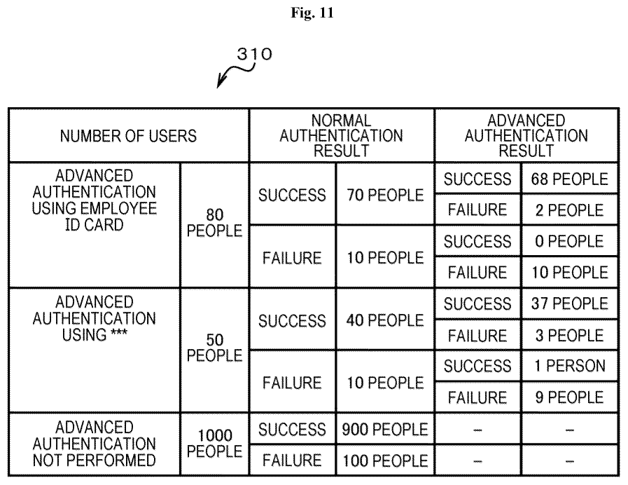

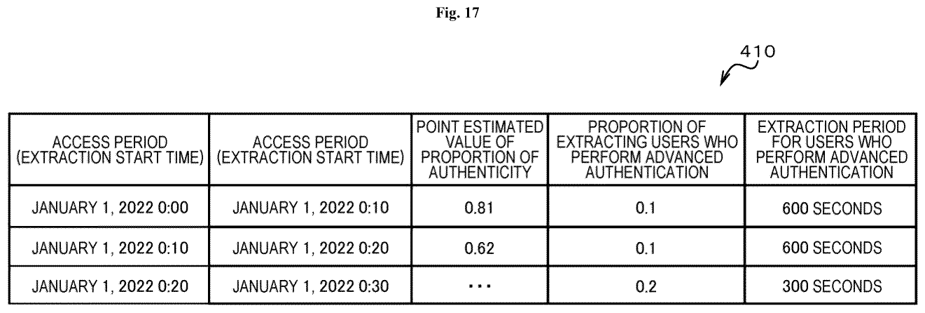

The storage circuitry 13 includes an authentication result DB 100 (see FIG. 9 to be described below in detail) that stores authentication results of normal authentication and advanced authentication, a behavior information DB 200 (see FIG. 10 to be described below in detail) that stores information regarding behavior (behavior information) of a user, a statistical information DB 300 (see FIG. 11 to be described below in detail) that stores statistical information calculated using the results of the normal authentication and the advanced authentication, and a sampling information DB 400 (see FIGS. 17 to 19 to be described below in detail).

The storage circuitry 13 temporarily stores a program for executing each function of the control circuitry 11 and information necessary for processing of the control circuitry 11.

The control circuitry 11 is responsible for overall processing executed by the identity score calculation device 10, and as illustrated in FIG. 8, includes an authentication result collection circuitry 111, a behavior information collection circuitry 112, an external server cooperation circuitry 113, an advanced authentication control circuitry 114, a statistical processing circuitry 115, a probability calculation circuitry 116, and a sampling control circuitry 117.

In a case where normal authentication and advanced authentication performed by the authentication device 20 are performed when a user accesses an account, the authentication result collection circuitry 111 acquires a result of the advanced authentication from the authentication device 20 and stores information of the authentication result (authentication result information 110) in the authentication result DB 100.

FIG. 9 is a diagram illustrating an example of a data configuration of the authentication result information 110 stored in the authentication result DB 100 according to the present embodiment.

As illustrated in FIG. 9, in the authentication result information 110, an access time to accounts, normal authentication results indicating whether normal authentication succeeds or fails, and advanced authentication results indicating results of advanced authentication are stored in association with account names that are IDs unique to users.

Note that, as an advanced authentication result, “success” or “failure” is stored in a case where advanced authentication is executed, and “not performed” is stored in a case where it is not a target of advanced authentication.

Referring back to FIG. 8, the behavior information collection circuitry 112 acquires information regarding a service use environment (access information) of a user and information regarding an action history (action history information) of a user, and stores the information in the behavior information DB 200 as behavior information 220.

FIG. 10 is a diagram illustrating an example of a data configuration of the behavior information 220 (access information 221 and action history information 222) stored in the behavior information DB 200 according to the present embodiment.

As illustrated in FIG. 10, in the access information 221, information such as access times, terminal types, and positions is stored in association with account names that are IDs unique to users as information regarding service use environments when the users access accounts. In addition, in a case where the terminal type is “smartphone”, address information of the smartphone necessary for SMS authentication, and in a case where the terminal type is “PC” and the user works at home, line information and the like are stored in association with the account name of the user.

Note that the behavior information collection circuitry 112 acquires the access information 221 by receiving information collected by the authentication device 20 from the user terminal 3.

Furthermore, the behavior information collection circuitry 112 acquires information regarding an action history (action history information 222) of a user from the external server 40 as an out-of-band system. For example, in a case where the out-of-band system is a room access management system of an office or the like, information of a room access time (room access management information) of a person associated with an account is acquired from a room access management server that is the external server 40 via the external server cooperation circuitry 113 as illustrated in FIG. 10, and is stored in the behavior information DB 200.

The external server cooperation circuitry 113 performs cooperation processing with various external servers 40 (out-of-band cooperation processing) for acquiring an action history of a user from a channel other than the channel (information transmission path) with the user terminals 3. For example, as described above, processing of generating a request message or a response message for transmitting and receiving a room access time or the like of a person associated with an account with the room access management server is performed.

The advanced authentication control circuitry 114 determines whether to perform advanced authentication for a user who has had access within a predetermined period. In order to ensure (Precondition 2) of Technical Idea 3 described above, the advanced authentication control circuitry 114 randomly selects a user for whom advanced authentication is performed from users for whom normal authentication has been performed.

Furthermore, the advanced authentication control circuitry 114, regarding the user for whom it is determined that advanced authentication will be performed, holds a correspondence relationship between the access information 221 and the action history information 222 that are information regarding the service use environment and advanced authentication in which the user is likely to succeed in authentication among a plurality of types of advanced authentication as a profile (analysis result) based on a predetermined logic using the behavior information 220 (FIG. 10).

For example, in a case where there is access from a smartphone immediately before, a profile of using SMS authentication is created as advanced authentication. In a case where there is an office room access record immediately before, a profile of using authentication using a smart card such as an employee ID card is created on the basis of room access management information of an office building or the like.

The advanced authentication control circuitry 114 determines, for a user for whom it is determined that advanced authentication will be performed, a method of the advanced authentication in which authentication is likely to succeed in a case of a person (user) associated with an account using the profile.

Then, the advanced authentication control circuitry 114 notifies the authentication device 20 of the advanced authentication method determined for the user associated with the account.

The statistical processing circuitry 115 calculates statistical values (numbers of users) as results of performing normal authentication and various types of advanced authentication for all users who have had access during a predetermined period, and stores the statistical values in the statistical information DB 300 as statistical information 310.

FIG. 11 is a diagram illustrating an example of a data configuration of the statistical information 310 stored in the statistical information DB 300 according to the present embodiment.

As illustrated in FIG. 11, for each advanced authentication method, results (success/failure) of the advanced authentication and results of the normal authentication of users for whom the advanced authentication has been performed are stored in association with each other as the statistical information 310. In addition, the results (success/failure) of normal authentication for users on which advanced authentication has not been performed are stored.

Referring back to FIG. 8, the probability calculation circuitry 116 performs point estimation of a proportion of authenticity of users (a probability of authenticity of users) who have accessed an account with reference to the statistical information 310 stored in the statistical information DB 300, and stores the estimate in the sampling information DB 400.

The probability calculation circuitry 116 calculates a probability of being an authentic person (PSP) for a user who has succeeded in normal authentication within a predetermined period using the above-described Formula (5).

Note that the probability calculation circuitry 116 may calculate a probability of being an authentic person (Pₜ) including a case where the authentic person has failed the normal authentication using Formula (9).

Which one of Formulas (5) and (9) is used by the probability calculation circuitry 116 as a calculation formula of a probability of authenticity of a user who has accessed an account is determined in advance. Then, the probability calculation circuitry 116 transmits a result of point estimation of the calculated proportion of authentic people to the authentication device 20.

The probability calculation circuitry 116 performs interval estimation with a confidence interval set in advance at the start of operation, using the result of point estimation.

The sampling control circuitry 117 uses the point estimated value or the interval estimated value (for example, the lower limit value) calculated by the probability calculation circuitry 116 to determine a proportion of extracting users who perform advanced authentication and an extraction period. In addition, the sampling control circuitry 117 stores the proportion of extracting users who perform advanced authentication and the extraction period in the sampling information DB 400.

### <Authentication Device>

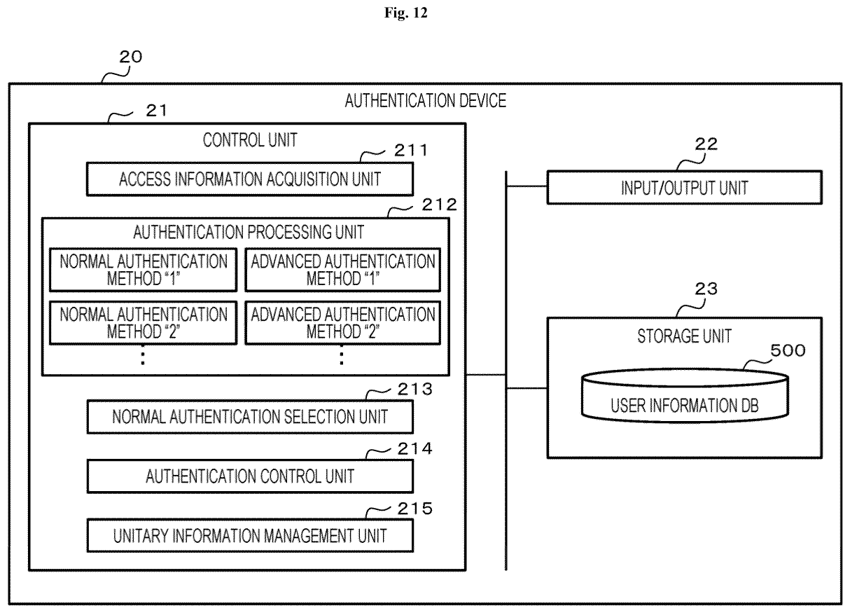

Next, the authentication device 20 according to the present embodiment will be described. FIG. 12 is a functional block diagram illustrating an example of a configuration of the authentication device 20 according to the present embodiment.

The authentication device 20 includes a plurality of types of methods of normal authentication (normal authentication methods) having different strengths and a plurality of types of methods of advanced authentication (advanced authentication methods). The authentication device 20 accepts an authentication request from the user terminal 3, performs preset normal authentication, and acquires information regarding a service use environment (access information 221) of a user. Then, the authentication device 20 transmits a result of the normal authentication and the access information 221 to the identity score calculation device 10. Furthermore, the authentication device 20 receives information of a determined advanced authentication method for a user for whom it is determined that advanced authentication will be performed from the identity score calculation device 10, performs the advanced authentication method, and then transmits the authentication result to the identity score calculation device 10.

Furthermore, the authentication device 20 acquires information of an authenticity probability (estimated value) of the user from the identity score calculation device 10, and selects an optimum normal authentication method in consideration of a threat due to an increase in a proportion of unauthentic people and convenience of the user.

The identity score calculation device 10 is configured with a computer including a control circuitry 21, an input/output circuitry 22, and a storage circuitry 23.

The input/output circuitry 22 inputs/outputs information to/from the identity score calculation device 10, the user terminal 3, the web server 51, the in-house system 52, the cloud service 53, and the like. The input/output circuitry 22 includes a communication interface for transmitting and receiving information via a communication line, and an input/output interface that inputs and outputs information to and from an input device such as a keyboard (not illustrated) and an output device such as a monitor (not illustrated).

The storage circuitry 23 is configured with a hard disk, a flash memory, a random access memory (RAM), or the like.

Information necessary for normal authentication of a user who has had access is stored in a user information DB 500 in the storage circuitry 23. For example, information such as an account name (user ID) and a password of the user who has had access, address information of the user terminal 3, and the like are stored. Furthermore, the user information DB 500 also stores information necessary for authentication when advanced authentication is performed. Note that the information necessary for advanced authentication may be acquired from the external server 40 or the like via the external server cooperation circuitry 113 (FIG. 8) of the identity score calculation device 10 and stored in the user information DB 500.

The storage circuitry 23 temporarily stores a program for executing each function of the control circuitry 21 and information necessary for processing of the control circuitry 21.

The control circuitry 21 is responsible for overall processing executed by the authentication device 20, and as illustrated in FIG. 12, includes an access information acquisition circuitry 211, an authentication processing circuitry 212, a normal authentication selection circuitry 213, an authentication control circuitry 214, and a circuitryary information management circuitry 215.

The access information acquisition circuitry 211 acquires a terminal type, position information, and the like as information regarding a service use environment (access information 221) of a user from a user terminal 3 of which a login request has been accepted. Then, the access information acquisition circuitry 211 transmits the access information 221 such as the terminal type and the position information together with the access time (for example, time when the login request is received) to the identity score calculation device 10.

The authentication processing circuitry 212 holds a plurality of types of normal authentication methods and a plurality of types of advanced authentication methods for a user who has accessed an account.

The authentication processing circuitry 212 performs authentication on a user who has had access using a set normal authentication method. Furthermore, the authentication processing circuitry 212 receives information of a determined advanced authentication method for a user for whom it is determined that advanced authentication will be performed from the identity score calculation device 10, selects the advanced authentication method from a plurality of advanced authentication methods, and performs authentication.

The authentication processing circuitry 212 transmits results (success/failure) of the normal authentication and the advanced authentication to the identity score calculation device 10.

The normal authentication selection circuitry 213 acquires a probability (estimated value) of authenticity of a user from the identity score calculation device 10 every predetermined period. Then, the normal authentication selection circuitry 213 selects an optimum normal authentication method from a plurality of normal authentication methods in consideration of a threat due to an increase in a proportion of unauthentic people and convenience of the user according to the acquired probability of the authenticity of the user.

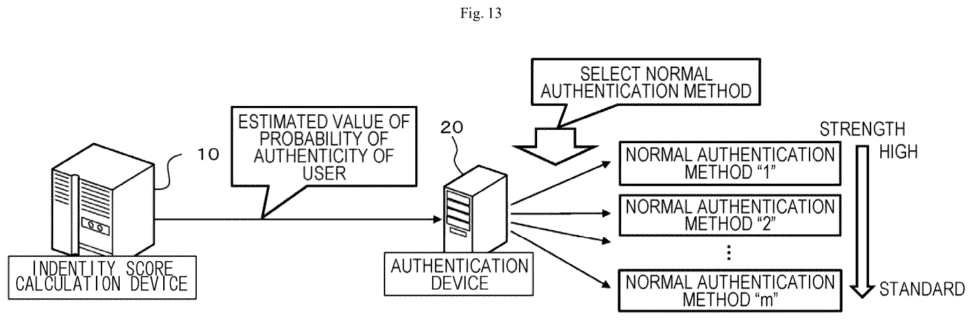

As illustrated in FIG. 13, the normal authentication methods are set in stages from a high-strength normal authentication method “1” to a low-strength (standard) normal authentication method “n”. Then, upon acquiring an estimated value of a probability of authenticity of a user from the identity score calculation device 10, for example, in a case where the estimated value of the probability of the authenticity of the user is equal to or larger than a predetermined threshold value, the normal authentication selection circuitry 213 selects a standard normal authentication method (for example, normal authentication method “n”) in consideration of convenience of the user. The standard normal authentication method “n” is, for example, authentication using a user ID and a password. On the other hand, in a case where the estimated value of the probability of the authenticity of the user is lower than the predetermined threshold value, the normal authentication selection circuitry 213 selects a normal authentication method having relatively high strength (for example, normal authentication method “1”) at the expense of the convenience of the user. The normal authentication method “1” having relatively high strength is, for example, biometric authentication or two-factor authentication.

The normal authentication selection circuitry 213 sets a normal authentication method by notifying the authentication processing circuitry 212 of information of the selected normal authentication method.

Referring back to FIG. 12, the authentication control circuitry 214 executes authentication processing with the user terminal 3 on the basis of a user authentication protocol such as Remote Authentication Dial In User Service (RADIUS), for example.

The circuitrry information management circuitry 215 implements single sign on (SSO) that enables use of a plurality of services using one ID and password using, for example, the Lightweight Directory Access Protocol (LDAP).

### <<Flow of Processing>>

Next, a flow of processing executed by the identity authentication system 1 according to the present embodiment will be described.

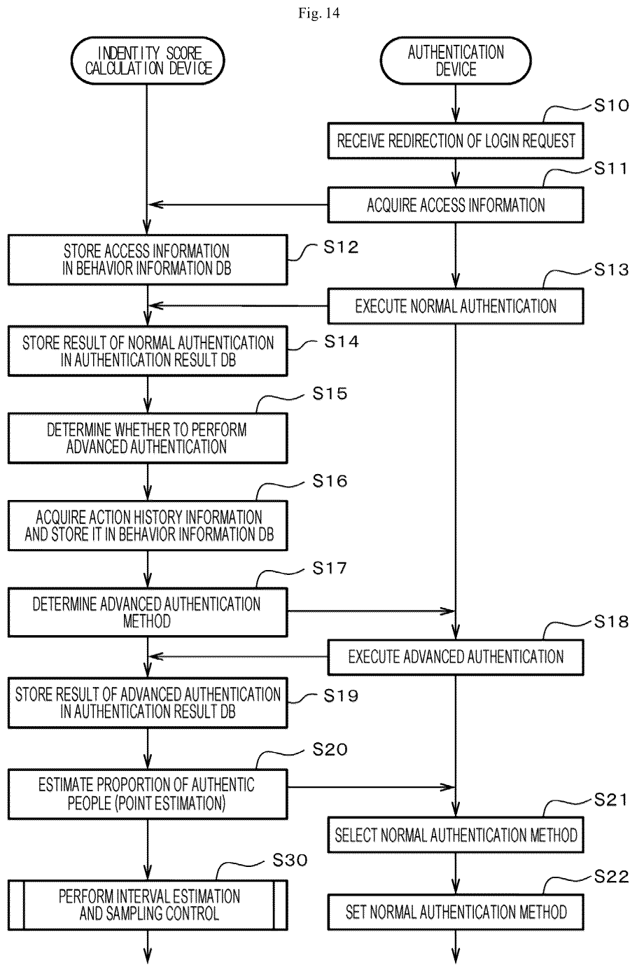

FIG. 14 is a sequence diagram illustrating a flow of processing executed by the identity authentication system 1.

Note that, here, description will be given assuming that information from a room access management system of an office or the like is acquired as the action history information 222 acquired from the external server 40. That is, description will be given assuming that the identity score calculation device 10 acquires, from the room access management server that is the external server 40, information of a room access time (room access management information) of people associated with accounts as indicated by the action history information 222 in FIG. 10.

The room access management system manages the entry and exit of users as follows, for example.

When a person associated with an account arrives at an office, the person enters a room by passing through a flapper gate or the like using an employee ID card including an IC card function (smart card). The room access management server acquires the ID of the user who has entered the room and the access time from the employee ID card, and records the ID and the access time in the own server. In this manner, the room access management server records the action history information 222 of the user.

Then, first, the user accesses the web server 51 and makes a login request in order to use a web service using the user terminal 3 (for example, a PC).

The web server 51 performs redirection to the authentication device 20 via the user terminal 3 to authenticate the user.

When the authentication device 20 receives the redirection of the login request (step S10), the access information acquisition circuitry 211 acquires a terminal type, position information, and the like from the user terminal 3 as information regarding a service use environment (access information 221) of the user (step S11). Then, the access information acquisition circuitry 211 transmits the access information 221 such as the terminal type and the position information together with the access time (for example, time when the login request is received) to the identity score calculation device 10.

Then, the behavior information collection circuitry 112 of the identity score calculation device 10 acquires the access information 221 from the authentication device 20 and stores the access information in the behavior information DB 200 (step S12).

Subsequently, the authentication processing circuitry 212 of the authentication device 20 executes normal authentication related to the user who has had access using a predetermined (initial setting) normal authentication method (step S13). Then, the authentication processing circuitry 212 transmits a result (success/failure) of the normal authentication to the identity score calculation device 10.

Upon acquiring the result of the normal authentication, the authentication result collection circuitry 111 of the identity score calculation device 10 stores the result in the authentication result DB 100 as the authentication result information 110 (FIG. 9) (step S14).

Next, the advanced authentication control circuitry 114 of the identity score calculation device determines whether to perform advanced authentication in addition to the normal authentication for the user who has had access within a predetermined period (step S15). The advanced authentication control circuitry 114 randomly determines whether the user is a user for whom the advanced authentication is performed.

For the user for whom the advanced authentication is performed, the behavior information collection circuitry 112 of the identity score calculation device 10 acquires information regarding an action history (action history information 222) of the user from the external server 40 (step S16), and stores the information in the behavior information DB 200.

Here, the behavior information collection circuitry 112 acquires, from the room access management server (external server 40), information of a room access time (room access management information) of a person associated with an account as the action history information 222.

Next, the advanced authentication control circuitry 114 of the identity score calculation device 10 determines, regarding a user for whom it is determined that advanced authentication will be performed, a method of the advanced authentication in which a person (user) associated with the account would be most likely to succeed in authentication with reference to the behavior information 220 (FIG. 10) (step S17). Then, the advanced authentication control circuitry 114 notifies the authentication device 20 of necessity (here, “necessary”) of the advanced authentication related to the user and the determined advanced authentication method.

Here, in a case where there is a record of an entry time but there is no record of an exit time, for example, as indicated by symbol y in FIG. 10, that is, in a case where it is estimated that there is a user in the office, the advanced authentication control circuitry 114 determines advanced authentication using an employee ID card (smart card) as an advanced authentication method in which a person associated with the account would be most likely to succeed in authentication by referring to the action history information 222 (room access management information).

The authentication processing circuitry 212 of the authentication device 20 executes the advanced authentication for the corresponding user using the advanced authentication method which has been notified (step S18). Here, the authentication processing circuitry 212 performs advanced authentication using an employee ID card on the user.

Then, for users who have succeeded in the advanced authentication by the authentication processing circuitry 212, login of the account is permitted for the web server 51 under the control of the authentication control circuitry 214 and the circuitry information management circuitry 215.

Subsequently, the authentication processing circuitry 212 of the authentication device 20 transmits a result (success/failure) of the advanced authentication to the identity score calculation device 10.

Then, upon acquiring the result of the advanced authentication, the authentication result collection circuitry 111 of the identity score calculation device 10 stores the result in the authentication result DB 100 as the authentication result information 110 (FIG. 9) (step S19).

Next, the statistical processing circuitry 115 of the identity score calculation device 10 calculates statistical values (numbers of users) as results of performing normal authentication and various types of advanced authentication for all users who have had access during a predetermined period, and stores the statistical values in the statistical information DB 300 as the statistical information 310 (FIG. 11).

Subsequently, the probability calculation circuitry 116 of the identity score calculation device 10 estimates the proportion of authentic people (point estimation) for all users including those who have not performed advanced authentication using the statistical information 310 (FIG. 11) (step S20).

An estimation of the proportion of authentic people (point estimation) is a calculation of the probability of authenticity.

Here, the probability calculation circuitry 116 calculates a probability of being an authentic person (P_{S}^{P}) for a user who has succeeded in normal authentication within a predetermined period using the above-described Formula (5).

As an example, the probability calculation circuitry 116 calculates the probability of being an authentic person (P_{S}^{P}) using Formula (5) by referring to the statistical information 310 illustrated in FIG. 11 to obtain the following score (point estimated value). For example, in a case where a plurality of users who have accessed the account have succeeded in normal authentication, calculation is performed using the statistical information DB 300 and the proportion of these users who are the same as people associated with the accessed accounts is estimated to be approximately 0.96 (point estimated value).

$$[ Math . 12 ]$$

$${P}_{S}^{P} = \frac{{N}_{2}^{( a + b )} - {β}_{1} {γ}_{1} {N}_{2}}{{N}_{2}^{( a + b )}} = \frac{70 + 40 + 900 - \frac{5}{24} \times \frac{24}{130} \times 1130}{70 + 40 + 900} = 0.96$$

Here, β₁=(2+3)/(2+10+3+9)=5/24 is defined. γ₁=(2+10+3+9)/(80+50)=24/130 is defined. N₂=80+50+1000=1130 is defined.

Furthermore, as an example, the probability calculation circuitry 116 calculates a probability of being an authentic person (Pₜ) including a case where the authentic person has failed the normal authentication using Formula (9).

As an example, the probability calculation circuitry 116 calculates the probability of being an authentic person (Pₜ) using Formula (9) by referring to the statistical information 310 illustrated in FIG. 11 to obtain the following score.

In other words, among all users who have accessed an account, including users who have failed normal authentication, the proportion of users that are the same as people associated with the account is estimated to be approximately 0.82 (=1−24/130) (point estimated value).

$$[ Math . 13 ]$$

$${P}_{t} = 1 - {γ}_{1} = 1 - \frac{24}{130} = approximately 0.82$$

Then, the probability calculation circuitry 116 transmits the calculated probability of authenticity of the users who have accessed the account (an estimation of the proportion of authentic people (point estimation)) to the authentication device 20.

Furthermore, the identity authentication system 1 performs processing of performing interval estimation and sampling control after processing of estimating the proportion of authentic people (point estimation) (step S30). A detailed flow of step S30 will be described later with reference to FIG. 15.

The normal authentication selection circuitry 213 of the authentication device 20 acquires an estimated value of a probability of authenticity of the user from the identity score calculation device 10 every predetermined period. Then, the normal authentication selection circuitry 213 selects an optimum normal authentication method from a plurality of types of normal authentication methods according to the acquired estimated value of the probability of the authenticity of the user (step S21).

For example, in a case where the estimated value of the probability of the authenticity of the user is equal to or larger than a predetermined threshold value, the normal authentication selection circuitry 213 selects a standard normal authentication method (for example, normal authentication method “n”) in consideration of convenience of the user. On the other hand, in a case where the estimated value of the probability of the authenticity of the user is lower than the predetermined threshold value, the normal authentication selection circuitry 213 selects a normal authentication method having relatively high strength (for example, normal authentication method “1”) at the expense of the convenience of the user.

The normal authentication selection circuitry 213 sets a normal authentication method by notifying the authentication processing circuitry 212 of information of the selected normal authentication method (step S22).

Note that, in a case where the estimated value calculated by “probability of authenticity of user who has succeeded in normal authentication” (Formula (5)) is used, the normal authentication selection circuitry 213 evaluates a threat from the proportion in which an unauthentic person is included in users who have succeeded in normal authentication, and selects normal authentication. On the other hand, in a case where the estimated value calculated by “probability of authenticity in case of including user who has failed normal authentication” (Formula (9)) is used and the proportion in which an authentic person is included in users who have failed normal authentication is large, a normal authentication method having relatively high strength is changed to a normal authentication method having standard strength from the viewpoint of convenience of a user while the above threat is taken into consideration.

In this way, according to the identity authentication system 1 according to the present embodiment, an optimum authentication method can be selected on the basis of an estimated value of authenticity of all users who have had access during a predetermined period.

### [Interval Estimation and Sampling Control]

FIG. 15 is a sequence diagram illustrating a flow of interval estimation and sampling control processing.

This flow starts after the processing of estimating the proportion of authentic people (point estimation) (step S20 in FIG. 14).

In step S31, the probability calculation circuitry 116 performs interval estimation with a confidence interval set in advance at the start of operation, using the result of point estimation of the proportion of authenticity of users. Note that step S31 is a specific example of the above [Technical idea 4: Interval Estimation for Evaluating Certainty of Authentic Person's Estimated Value]. By executing interval estimation, it is possible to evaluate the certainty of the estimated value, and it is possible to consider the influence of the authentic person failing super strong authentication (False Negative).

Hereinafter, steps S32 to S35 are specific examples of the above [Technical idea 5: Processing of Sampling Users Who Perform Advanced Authentication].

In step S32, the sampling control circuitry 117 determines whether the point estimated value is equal to or smaller than a reference value. In a case where the point estimated value is larger than the reference value (S32: No), the processing of this flow ends.

In a case where the point estimated value is equal to or smaller than the reference value (S32: Yes), in step S33, the sampling control circuitry 117 compares the point estimated value with the previous point estimated value.

In step S34, the sampling control circuitry 117 determines whether the difference from the previous point estimated value is equal to or larger than a reference value (see step S1 in FIG. 7). In a case where the difference from the previous point estimated value is smaller than the reference value (S34: No), the processing of this flow ends.

In a case where the difference from the previous point estimated value is equal to or larger than the reference value (S34: Yes), in step S35, the sampling control circuitry 117 changes the sampling proportion and the extraction period, and ends the processing of this flow. Details of the sampling proportion and the extraction period will be described later with reference to FIGS. 17 to 19.

In this way, in steps S32 to S35, the proportion of samples (users who perform advanced authentication) and the extraction period are controlled using the estimated value to follow the change in the proportion of authentic people at the time of operation.

### [Application Example of Estimating Proportion of Authenticity of Users]

An application example of estimating the proportion of authenticity of users will be described.

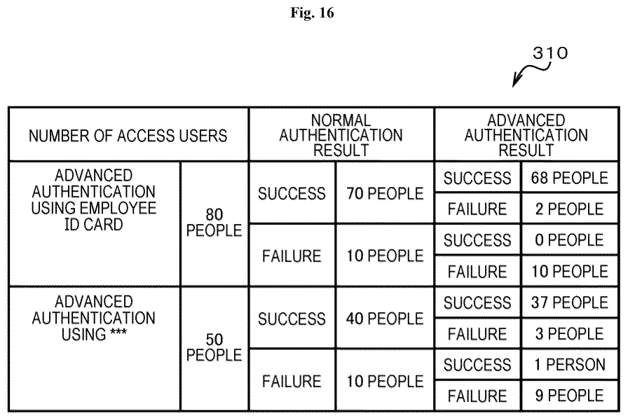

FIG. 16 is a diagram illustrating an example of a data configuration of the statistical information 310 stored in the statistical information DB 300 (FIG. 8) according to the present embodiment.

Using the statistical information 310 (FIG. 16), the identity score calculation device 10 (FIG. 8) uses a proportion (denoted as p) of users who are the same as people associated with the accessed account, among the users who have accessed the account, to estimate the confidence interval of the proportion.

For example, in a case where the user who has accessed the account has succeeded in normal authentication, when the confidence interval is approximately 0.95 (T≈1.96), the point estimated value is approximately 0.96 as described above, and thus, the following is obtained. Note that T is the upper limit value of the random variable in the confidence interval (1-α) in the standard normal distribution.

$$[ Math . 14 ]$$

$$0.96 - \frac{1.96}{\sqrt{70 + 40}} \times \sqrt{0.96 \times 0. 04} \times ≦ p ≦ 0. 96 + \frac{1.96}{\sqrt{70 + 40}} \times \sqrt{0.96 \times 0. 04}$$

Each side is calculated, and

$$0.923 \leq p \leq 0.997$$

is estimated (using Formula (12) with the correction term omitted).

Furthermore, in a case where users who have failed normal authentication are also included (in the case of all users who have performed advanced authentication), when the confidence interval is approximately 0.95 (T≈1.96), the point estimated value is approximately 0.82, and thus, the following is obtained.

$$[ Math . 15 ]$$

$$0.82 - \frac{1.96}{\sqrt{80 + 50}} \times \sqrt{0.82 \times 0. 18} ≦ p ≦ 0.82 + \frac{1.96}{\sqrt{80 + 50}} \times \sqrt{0.82 \times 0. 18}$$

Each side is calculated, and

$$0.753 \leq p \leq 0.887$$

is estimated (using Formula (12) with the correction term omitted).

### [Application Example of Sampling Control of Users Who Perform Advanced Authentication]

An application example of sampling control of users who perform advanced authentication will be described.

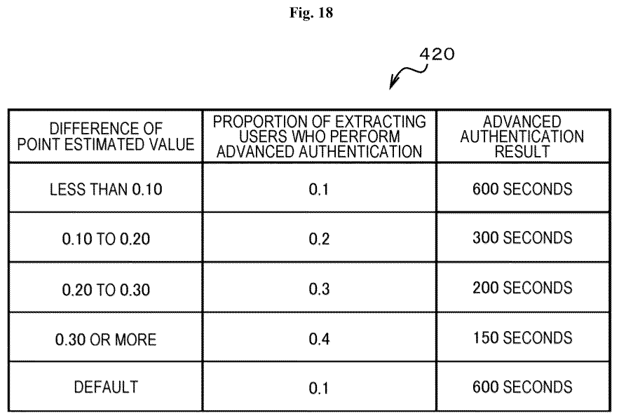

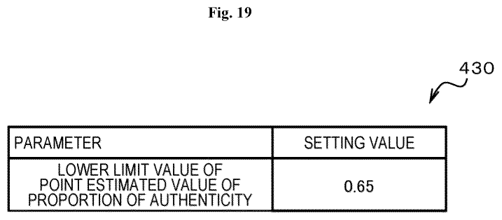

FIG. 17 is a diagram illustrating an example of a data configuration of sampling history information 410 stored in the sampling information DB 400 (FIG. 8) according to the present embodiment. FIG. 18 is a diagram illustrating an example of a data configuration of list information 420 of extraction proportions and extraction periods for each difference of point estimated values stored in the sampling information DB 400 according to the present embodiment. FIG. 19 is a diagram illustrating threshold value information 430 stored in the sampling information DB 400 according to the present embodiment.

### <Procedure 1>

In a case where the point estimated value of the proportion of authenticity of all users who have had access during a certain period is equal to or smaller than a preset reference value (0.65 based on the threshold value information 430 in FIG. 19), the identity score calculation device 10 (FIG. 8) compares the point estimated value with the previous point estimated value and calculates the difference therebetween.

### <Procedure 2>

The identity score calculation device 10 acquires a proportion of extracting users who perform advanced authentication and an extraction period, which correspond to the calculated difference, from the preset ones stored in (the list information 420 of extraction proportions and extraction periods for each difference of point estimated values in FIG. 18), and sets the acquired proportion and extraction period as the next extraction proportion and extraction period. Note that the default in FIG. 18 is applied in a case where the value does not fall below the lower limit value of the point estimated value of the proportion of authenticity (see the threshold value information 430 in FIG. 19).

### <Procedure 3>

The identity score calculation device 10 stores an access period, an extraction proportion, and an extraction period for the next point estimation of a proportion of authenticity in (the sampling history information 410 in FIG. 17) of the sampling information DB 400 (FIG. 8). In addition, after the next access period, the identity score calculation device 10 stores the point estimated value of the proportion of authenticity for the corresponding access period calculated by the probability calculation circuitry 116 (FIG. 8) in (the sampling history information 410 in FIG. 17) of the sampling information DB 400.

Note that the values of the extraction proportion and the extraction period in (the list information 420 of the extraction proportions and the extraction periods for each difference of point estimated values in FIG. 18) may be dynamically changed according to the amount of access by users. For example, in a case where the amount of access is low, such as late at night, the default extraction period may be lengthened, or the extraction proportion may be increased when the difference of point estimated values is 0.3 or more.

### <Hardware Configuration>

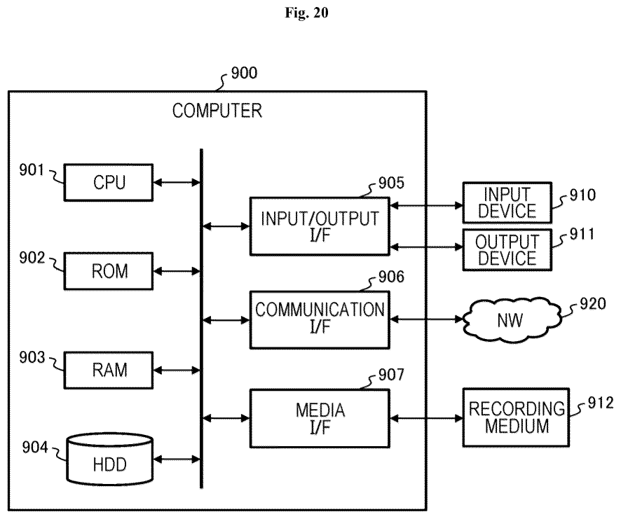

The identity score calculation device 10 and the authentication device 20 according to the present embodiment are implemented by a computer 900 having a configuration as illustrated in FIG. 20, for example.

FIG. 20 is a hardware configuration diagram illustrating an example of the computer 900 that implements functions of the identity score calculation device 10 and the authentication device 20 according to the present embodiment. The computer 900 includes a central processing circuitry (CPU) 901, a read only memory (ROM) 902, a RAM 903, a hard disk drive (HDD) 904, an input/output interface (I/F) 905, a communication I/F 906, and a media I/F 907.

The CPU 901 operates on the basis of a program stored in the ROM 902 or the HDD 904, and performs control with a control circuitry. The ROM 902 stores a boot program to be executed by the CPU 901 when the computer 900 is started, a program related to hardware of the computer 900, and the like.

The CPU 901 controls an input device 910 such as a mouse or a keyboard and an output device 911 such as a display or a printer via the input/output I/F 905. The CPU 901 acquires data from the input device 910 and outputs generated data to the output device 911 via the input/output I/F 905. Note that a graphics processing circuitry (GPU) or the like may be used as a processor together with the CPU 901.

The HDD 904 stores a program to be executed by the CPU 901, data to be used by the program, and the like. The communication I/F 906 receives data from another device via a communication network (for example, a network (NW) 920), outputs the data to the CPU 901, and transmits data generated by the CPU 901 to another device via the communication network.

The media I/F 907 reads a program or data stored in a recording medium 912, and outputs the program or data to the CPU 901 via the RAM 903. The CPU 901 loads a program related to target processing from the recording medium 912 onto the RAM 903 via the media I/F 907, and executes the loaded program. The recording medium 912 is an optical recording medium such as a digital versatile disc (DVD) or a phase change rewritable disk (PD), a magneto-optical recording medium such as a magneto optical disk (MO), a magnetic recording medium, a semiconductor memory, or the like.

For example, in a case where the computer 900 functions as the identity score calculation device 10 and the authentication device 20 of the present invention, the CPU 901 of the computer 900 achieves the functions of the identity score calculation device 10 and the authentication device 20 by executing the program loaded on the RAM 903. Further, the HDD 904 stores data in the RAM 903. The CPU 901 reads a program related to target processing from the recording medium 912, and executes the program. Additionally, the CPU 901 may read the program related to the target processing from another device via the communication network (NW 920).

### <Effects>

Hereinafter, the effects of the identity score calculation device 10 and the like according to the present invention will be described.

The identity score calculation device 10 according to the present invention is an identity score calculation device 10 that is connected to an authentication device 20 that performs user authentication and calculates a score indicating authenticity of a user, wherein the authentication device 20 includes a plurality of types of normal authentication means for normal authentication in which authentication having standard authentication strength is performed, and a plurality of types of advanced authentication means for advanced authentication of which strength is set in such a manner that failure of authentication is reduced to a first predetermined level or less when a user is an authentic person and success of authentication is reduced to a second predetermined level or less when a user is not an authentic person, the identity score calculation device including: a behavior information collection circuitry 112 that collects behavior information 220 indicating access information 221 indicating a service use environment in which a user has accessed an account via a user terminal and action history information 222 of the user; an authentication result collection circuitry 112 that collects, from the authentication device 20, authentication result information 110 indicating success or failure of the normal authentication and the advanced authentication; an advanced authentication control circuitry 114 that determines whether to execute the advanced authentication in addition to the normal authentication for a user who has accessed an account within a predetermined period, determines, regarding a user for whom it is determined that the advanced authentication will be executed, one of the advanced authentication means that reduces failure of authentication to the first predetermined level or less when a user is an authentic person among the plurality of types of advanced authentication means with reference to the behavior information 220, and notifies the authentication device 20 of the one of the advanced authentication means determined for the user for whom it is determined that the advanced authentication will be executed; and
a probability calculation circuitry 116 that calculates a point estimated value by performing point estimation of a proportion of users who are authentic people among all users who have accessed an account, including those who have not performed advanced authentication, on the basis of a statistical value obtained from the authentication result information 110 on a number of users who have succeeded in the normal authentication, a number of users who have failed the normal authentication, a number of users who have succeeded in the advanced authentication and a number of users who have failed the advanced authentication, wherein the probability calculation circuitry 114 performs interval estimation on the basis of the point estimated value within a preset confidence interval, which is a possible range of values for the proportion of users who are authentic people.

In this way, the identity score calculation device 10 can perform interval estimation of the proportion of authenticity of users who have had access during a certain period, and quantitatively visualize the certainty of the estimated value. For example, when the user uses electronic commerce, membership-based web services (online supermarkets, job-hunting sites, etc.), an in-house online system, or the like, it is possible to quantitatively estimate whether the user who accesses the web service or the account of the online system is an authorized user.

That is, the identity score calculation device 10 can evaluate the certainty of the estimated value by performing the interval estimation in cooperation with the point estimation of the proportion of authentic people. Accordingly, it is possible to consider the influence of the authentic person failing the advanced authentication (False Negative). As a result, by estimating the possible range (confidence interval) of the value of the proportion of authenticity of users with the accuracy required for the operation of the network, it is possible to take security measures based on an upper limit value and a lower limit value of the estimated amount of unauthorized access to the network.

In addition, it is possible to suppress the influence of the number of authentic people who fail advanced authentication on the estimated value of the proportion of authenticity of users. As a result, even when considering cases where the authentic person fails advanced authentication, it is possible to count only the number of users who have succeeded in advanced authentication and approximate the error in the width of the confidence interval to be on the safe side (estimate the width to be wide) and almost zero.

Note that effects of the processing at the preceding stage of point estimation of the proportion of authenticity will be described.

The identity score calculation device 10 can calculate authenticity for all users who access an account as a probability as an objective numerical value using observable information without depending on a unique standard of the device or know-how different for each product.

That is, since a proportion of access to the account by an unauthentic person can be evaluated, in a case where unauthorized access increases or the like, unique advanced know-how or the like regarding other products or devices that score the authenticity is unnecessary. Furthermore, since authenticity of a user is quantified as a probability using observable information (authentication results of normal authentication and advanced authentication) related to a person associated with an account, the need for advanced knowledge and insight of a maintenance person such as past service operation results can be unnecessary.

In the identity score calculation device 10, the probability calculation circuitry 116 performs the interval estimation according to aforementioned Formula (12) for the interval estimation for the proportion p of authentic people.

In this way, the identity score calculation device 10 can control the proportion of samples (users who perform the advanced authentication) and the extraction period according to the amount of change in the proportion of authentic people on the basis of the confidence interval (for example, 95%) of the estimated value obtained in the operating environment by performing the interval estimation of the proportion of authentic people.

In the identity score calculation device 10, the probability calculation circuitry 116 provides a center value correction term for correcting an error in a center value of the confidence interval, and performs the interval estimation in the confidence interval using the center value correction term.

In this way, by providing the center value correction term for correcting the error in the center value of the confidence interval, the identity score calculation device 10 can evaluate the error in the width of the confidence interval to be on the safe side in terms of NW security even if the error occurs in the center value of the confidence interval.

In the identity score calculation device 10, the probability calculation circuitry 116 provides a width value correction term for correcting an error in a width value of the confidence interval, and performs the interval estimation in the confidence interval using the width value correction term.

In this way, by providing the width value correction term for correcting the error in the width value of the confidence interval, the identity score calculation device 10 can evaluate the error in the width of the confidence interval to be on the safe side in terms of NW security even if the error occurs in the width value of the confidence interval.

The identity score calculation device 10 further includes a sampling control circuitry 117 that uses the point estimated value calculated by the probability calculation circuitry 116 to control a proportion of extracting users who perform advanced authentication and/or an extraction period for sampling users who perform advanced authentication.

In this way, the identity score calculation device 10 can control the proportion of samples (users who perform advanced authentication) and the extraction period using the point estimated value to follow the change in the proportion of authentic people at the time of operation. That is, in an environment where the proportion of authenticity of users who access an account during a certain period changes, by controlling the proportion of extracting users who perform advanced authentication and the extraction period, it is possible to estimate the proportion of authenticity following the change in the proportion of authenticity of users. As a result, security measures according to the change in the amount of unauthorized access to the network can be performed more accurately.

The identity authentication system according to the present invention is an identity authentication system 1 including an identity score calculation device 10 that calculates a score indicating authenticity of a user and an authentication device 20 that performs user authentication, in which the authentication device 20 includes a plurality of types of normal authentication means for normal authentication in which authentication having standard authentication strength is performed, and a plurality of types of advanced authentication means for advanced authentication of which strength is set in such a manner that failure of authentication is reduced to a first predetermined level or less when a user is an authentic person and success of authentication is reduced to a second predetermined level or less when a user is not the authentic person, the identity score calculation device 10 includes: a behavior information collection circuitry 112 that collects behavior information 220 indicating access information 221 indicating a service use environment in which a user has accessed an account via a user terminal 3 and action history information 222 of the user; an authentication result collection circuitry 111 that collects, from the authentication device 20, authentication result information 110 indicating success or failure of the normal authentication and the advanced authentication; an advanced authentication control circuitry 114 that determines whether to execute the advanced authentication in addition to the normal authentication for a user who has accessed an account within a predetermined period, determines, regarding a user for whom it is determined that the advanced authentication will be executed, one of the advanced authentication means that reduces failure of authentication to the first predetermined level or less when the user is the authentic person among the plurality of types of advanced authentication means with reference to the behavior information 220, and notifies the authentication device 20 of the one of the advanced authentication means determined for the user for whom it is determined that the advanced authentication will be executed; and a probability calculation circuitry 116 that calculates a point estimated value by performing point estimation of a proportion of users who are authentic people among all users who have accessed an account, including those who have not performed advanced authentication, on the basis of a statistical value obtained from the authentication result information 110 on a number of users who have succeeded in the normal authentication, a number of users who have failed the normal authentication, a number of users who have succeeded in the advanced authentication and a number of users who have faced the advanced authentication, and performs interval estimation on the basis of the point estimated value within a preset confidence interval, which is a possible range of values for the proportion of users who are authentic people, and the authentication device 20 includes an authentication processing circuitry 212 that executes normal authentication by predetermined normal authentication means for a user who has accessed an account, executes advanced authentication by the one of the advanced authentication means which has been notified from the identity score calculation device 10 for a user for whom it is determined that the advanced authentication will be executed, and transmits the authentication result information of the normal authentication and the advanced authentication to the identity score calculation device 10.

In this way, the identity authentication system 1 can perform interval estimation of the proportion of authenticity of users who have had access during a certain period, and quantitatively visualize the certainty of the estimated value. Therefore, by estimating the possible range (confidence interval) of the value of the proportion of authenticity of users with the accuracy required for the operation of the network, it is possible to take security measures based on an upper limit value and a lower limit value of the estimated amount of unauthorized access to the network.

In addition, it is possible to suppress the influence of the number of authentic people who fail advanced authentication on the estimated value of the proportion of authenticity of users. As a result, even when considering cases where the authentic person fails advanced authentication, it is possible to count only the number of users who have succeeded in advanced authentication and approximate the error in the width of the confidence interval to be on the safe side (estimate the width to be wide) and almost zero.

### [Effects in Application Example of Identity Score Calculation Device 10]

In the identity score calculation device 10, in a case where a center value correction term is not used, the probability calculation circuitry 116 may select predetermined advanced authentication on the basis of the behavior of the user and perform interval estimation.

In a case where it is difficult for the identity score calculation device 10 to observe the proportion of authentic people who have failed authentication (users who have failed authentication include unauthentic people), it is difficult to calculate the correction term for the center value of the confidence interval. In such a case, the center value correction term is omitted, and the optimum advanced authentication is selected on the basis of the user's behavior, thereby reducing the probability of authentication failure. Here, in a case where there is no center value correction term, an error will occur in the center value of the confidence interval, but the value will be estimated to be small. Therefore, the proportion of authentic people will be evaluated on the safe side in terms of NW security. Moreover, the smaller the proportion of authentic people who have failed authentication, the smaller the value of the correction term. From these points, the center value correction term can be omitted.

In the identity score calculation device 10, in a case where the correction term for the width value of the confidence interval is not used, the probability calculation circuitry 116 may select predetermined advanced authentication on the basis of the behavior of the user and perform interval estimation.

In a case where it is difficult for the identity score calculation device 10 to observe the proportion of authentic people who have failed authentication (users who have failed authentication include unauthentic people), it is difficult to calculate the correction term for the center value of the confidence interval. In such a case, the center value correction term is omitted, and the optimum advanced authentication is selected on the basis of the user's behavior, thereby reducing the probability of authentication failure. Here, in a case where there is no width value correction term, an error will occur in the width value of the confidence interval, but the value will be estimated to be large (the width will be widened). Therefore, the evaluation will be performed on the safe side in terms of NW security.

The value of the correction term decreases as the proportion of authentic people who have failed authentication increases, but it can be assumed that the value is approximately −0.1% to −1% at the maximum in the actual operation range of the network. From these points, the width value correction term can be omitted.

In the identity score calculation device 10, the sampling control circuitry 117 may set an interval estimated value such that the amount of change in the proportion of authentic people complies with a predetermined reference in a case where the point estimated value is equal to or smaller than the predetermined reference value, and control the proportion of extracting users who perform advanced authentication on the basis of the interval estimated value and/or the period for sampling users who perform advanced authentication.

In this way, the identity score calculation device 10 sets the interval estimated value such that the amount of change in the proportion of authentic people complies with a predetermined reference, so that the change in the proportion of authentic people at the time of operation can be followed in consideration of the convenience of the user.

Note that the present invention is not limited to the above-described embodiment, and many modifications can be made by those skilled in the art within the technical idea of the present invention.

### REFERENCE SIGNS LIST

1 Identity authentication system
3 User terminal
10 Identity score calculation device
20 Authentication device
40 External server
51 Web server
52 In-house system
53 Cloud service
11, 21 Control circuitry
12, 22 Input/output circuitry
13, 23 Storage circuitry
100 Authentication result DB
110 Authentication result information
111 Authentication result collection circuitry
112 Behavior information collection circuitry
113 External server cooperation circuitry
114 Advanced authentication control circuitry
115 Statistical processing circuitry
116 Probability calculation circuitry
117 Sampling control circuitry
200 Behavior information DB
211 Access information acquisition circuitry
212 Authentication processing circuitry
213 Normal authentication selection circuitry
214 Authentication control circuitry
215 Circuitry information management circuitry
220 Behavior information
221 Access information
222 Action history information
300 Statistical information DB
310 Statistical information
400 Sampling information DB
410 Sampling history information
420 List information of extraction proportions and extraction periods for each difference of point estimated values
430 Threshold value information
500 User information DB

1. An identity score calculation device that is connected to an authentication device that performs user authentication and calculates a score indicating authenticity of a user, wherein the authentication device includes a plurality of types of normal authentication means for normal authentication in which authentication having standard authentication strength is performed, and a plurality of types of advanced authentication means for advanced authentication of which strength is set in such a manner that failure of authentication is reduced to a first predetermined level or less when a user is an authentic person and success of authentication is reduced to a second predetermined level or less when a user is not an authentic person, the identity score calculation device comprising:
a behavior information collection circuitry that collects behavior information indicating access information indicating a service use environment in which a user has accessed an account via a user terminal and action history information of the user;
an authentication result collection circuitry that collects, from the authentication device, authentication result information indicating success or failure of the normal authentication and the advanced authentication;
an advanced authentication control circuitry that determines whether to execute the advanced authentication in addition to the normal authentication for a user who has accessed an account within a predetermined period, determines, regarding a user for whom it is determined that the advanced authentication will be executed, one of the advanced authentication means that reduces failure of authentication to the first predetermined level or less when a user is an authentic person among the plurality of types of advanced authentication means with reference to the behavior information, and notifies the authentication device of the one of the advanced authentication means determined for the user for whom it is determined that the advanced authentication will be executed; and
a probability calculation circuitry that calculates a point estimated value by performing point estimation of a proportion of users who are authentic people among all users who have accessed an account, including those who have not performed advanced authentication, on the basis of a statistical value obtained from the authentication result information on a number of users who have succeeded in the normal authentication, a number of users who have failed the normal authentication, a number of users who have succeeded in the advanced authentication and a number of users who have failed the advanced authentication, wherein
the probability calculation circuitry performs interval estimation on the basis of the point estimated value within a preset confidence interval, which is a possible range of values for the proportion of users who are authentic people.

2. The identity score calculation device according to claim 1, wherein
the probability calculation circuitry
performs the interval estimation according to a following interval estimation formula for a proportion p of authentic people.

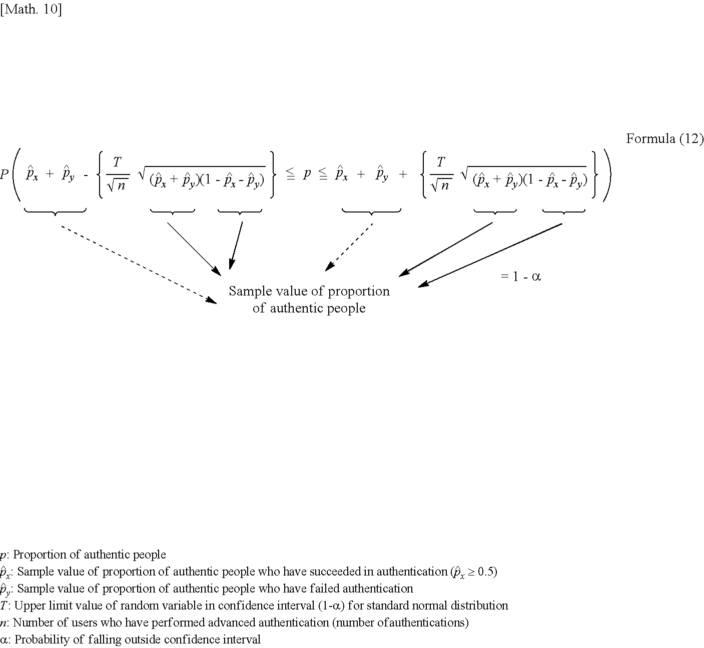

3. The identity score calculation device according to claim 1, wherein
the probability calculation circuitry provides a center value correction term for correcting an error in a center value of the confidence interval, and performs interval estimation in the confidence interval using the center value correction term.

4. The identity score calculation device according to claim 1, wherein
the probability calculation circuitry provides a width value correction term for correcting an error in a width value of the confidence interval, and performs the interval estimation in the confidence interval using the width value correction term.

5. The identity score calculation device according to claim 1, comprising:
a sampling control circuitry that uses the point estimated value calculated by the probability calculation circuitry to control a proportion of extracting users who perform advanced authentication and/or an extraction period for sampling users who perform advanced authentication.

6. An identity authentication system comprising an identity score calculation device that calculates a score indicating authenticity of a user and an authentication device that performs user authentication, wherein
the authentication device includes a plurality of types of normal authentication means for normal authentication in which authentication having standard authentication strength is performed, and a plurality of types of advanced authentication means for advanced authentication of which strength is set in such a manner that failure of authentication is reduced to a first predetermined level or less when a user is an authentic person and success of authentication is reduced to a second predetermined level or less when the user is not the authentic person,
the identity score calculation device includes:
a behavior information collection circuitry that collects behavior information indicating access information indicating a service use environment in which a user has accessed an account via a user terminal and action history information of the user;
an authentication result collection circuitry that collects, from the authentication device, authentication result information indicating success or failure of the normal authentication and the advanced authentication;
an advanced authentication control circuitry that determines whether to execute the advanced authentication in addition to the normal authentication for a user who has accessed an account within a predetermined period, determines, regarding a user for whom it is determined that the advanced authentication will be executed, one of the advanced authentication means that reduces failure of authentication to the first predetermined level or less when the user is the authentic person among the plurality of types of advanced authentication means with reference to the behavior information, and notifies the authentication device of the one of the advanced authentication means determined for the user for whom it is determined that the advanced authentication will be executed; and
a probability calculation circuitry that calculates a point estimated value by performing point estimation of a proportion of users who are authentic people among all users who have accessed an account, including those who have not performed advanced authentication, on the basis of a statistical value obtained from the authentication result information on a number of users who have succeeded in the normal authentication, a number of users who have failed the normal authentication, a number of users who have succeeded in the advanced authentication and a number of users who have failed the advanced authentication, wherein
the probability calculation circuitry performs interval estimation on the basis of the point estimated value within a preset confidence interval, which is a possible range of values for the proportion of users who are authentic people, and
the authentication device includes
an authentication processing circuitry that executes normal authentication by predetermined normal authentication means for a user who has accessed an account, executes the advanced authentication by the one of the advanced authentication means notified from the identity score calculation device for the user for whom it is determined that the advanced authentication will be executed, and transmits the authentication result information of the normal authentication and the advanced authentication to the identity score calculation device.

7. An identity authentication method performed by an identity score calculation device which is implemented by a computer including a CPU, the identity score calculation device being connected to an authentication device that performs user authentication and calculating a score indicating authenticity of a user, wherein
the authentication device includes a plurality of types of normal authentication means for normal authentication in which authentication having standard authentication strength is performed, and a plurality of types of advanced authentication means for advanced authentication of which strength is set in such a manner that failure of authentication is reduced to a first predetermined level or less when a user is an authentic person and success of authentication is reduced to a second predetermined level or less when the user is not the authentic person, the method comprising causing the CPU of the identity score calculation device to execute:
collecting behavior information indicating access information indicating a service use environment in which a user has accessed an account via a user terminal and action history information of the user;
collecting, from the authentication device, authentication result information indicating success or failure of the normal authentication and the advanced authentication;
determining whether to execute the advanced authentication in addition to the normal authentication for a user who has accessed an account within a predetermined period, determining, regarding a user for whom it is determined that the advanced authentication will be executed, one of the advanced authentication means that reduces failure of authentication to the first predetermined level or less when a user is an authentic person among the plurality of types of advanced authentication means with reference to the behavior information, and notifying the authentication device of the one of the advanced authentication means determined for the user for whom it is determined that the advanced authentication will be executed;
calculating a point estimated value by performing point estimation of a proportion of users who are authentic people among all users who have accessed an account, including those who have not performed advanced authentication, on the basis of a statistical value obtained from the authentication result information on a number of users who have succeeded in the normal authentication, a number of users who have failed the normal authentication, a number of users who have succeeded in the advanced authentication and a number of users who have failed the advanced authentication; and
performing interval estimation on the basis of the point estimated value within a preset confidence interval, which is a possible range of values for the proportion of users who are authentic people.

8. A non transitory computer readable medium storing a computer program, the computer program, when executed by a computer including a CPU, causing the CPU of the computer to function as the identity score calculation device according to claim 1.
